(19) United States
(12) Patent Application Publication
(10) Pub. No.: US 2014/0295263 A1
(43) Pub. Date: Oct. 2, 2014

(54) SECONDARY BATTERY

(71) Applicant: Sony Corporation, Tokyo (JP)

(72) Inventors: Masayuki Iwama, Fukushima (JP); Kaoru Abe, Fukushima (JP); Keiichi Kagami, Fukushima (JP); Kenichi Kawase, Fukushima (JP); Tomoo Takada, Fukushima (JP)

(73) Assignee: Sony Corporation, Tokyo (JP)

(21) Appl. No.: 14/220,816

(22) Filed: Mar. 20, 2014

(30) Foreign Application Priority Data
Mar. 26, 2013 (JP) 2013-064399

(51) Int. Cl. H01M 10/42

(52) U.S. Cl. CPC H01M 10/4235
USPC 429/211

(57) ABSTRACT

A secondary battery includes: a cathode and an anode that are opposed to each other with a separator in between; and an electrolytic solution, wherein the cathode includes a cathode current collector and a cathode active material layer provided between the cathode current collector and the separator, the anode includes an anode current collector and an anode active material layer provided between the anode current collector and the separator, one or more of the cathode, the anode, and the separator includes a plurality of thermally-conductive particles in a region between the cathode current collector and the anode current collector, and heat conductivity of the thermally-conductive particles is larger in a second direction that intersects with a first direction, in which the cathode and the anode are opposed to each other, than in the first direction.

### CROSS REFERENCE TO RELATED APPLICATIONS

This application claims the benefit of Japanese Priority Patent Application JP 2013-64399 filed on Mar. 26, 2013, the entire contents of which are incorporated herein by reference.

### BACKGROUND

The present technology relates to a secondary battery in which a cathode and an anode are opposed to each other with a separator in between.

In recent years, various electronic apparatuses such as a mobile phone and a personal digital assistant (PDA) have been widely used, and it has been demanded to further reduce the size and the weight of the electronic apparatuses and to achieve their long life. Accordingly, as an electric power source for the electronic apparatuses, a battery, in particular, a small and light-weight secondary battery capable of providing high energy density has been developed.

In these days, it has been considered to apply such a secondary battery to various other applications in addition to the foregoing electronic apparatuses. Examples of such other applications may include a battery pack attachably and detachably mounted on the electronic apparatuses or the like, an electric vehicle such as an electric automobile, an electric power storage system such as a home electric power server, and an electric power tool such as an electric drill.

Secondary batteries utilizing various charge-discharge principles to obtain a battery capacity have been proposed. In particular, a secondary battery utilizing insertion and extraction of an electrode reactant, a secondary battery utilizing precipitation and dissolution of an electrode reactant, and the like have attracted attention, since these secondary batteries provide higher energy density than a lead battery, a nickel-cadmium battery, and the like.

The secondary battery includes an electrolytic solution together with a cathode and an anode that are opposed to each other with a separator in between. The cathode includes a cathode active material as an active material engaged in a charge-discharge reaction, and the anode includes an anode active material as an active material engaged in a charge-discharge reaction.

In order to improve performance of secondary batteries, not only to improve basic characteristics such as capacity characteristics and cycle characteristics, but also to improve safety is also important. In terms thereof, since configurations of secondary batteries largely affect the basic characteristics and the safety, various studies have been made on the configurations of the secondary batteries for various purposes.

Specifically, in order to improve conservation characteristics under high temperature, a predetermined amount of a boron compound such as B₂O₃ is added to a cathode active material represented by a general formula of Li_{X}Ni_{1-Y}Co_{Y}O_{Z} (0<X<1.3, 0≦Y≦1, 1.8<Z<2.2) (for example, see Japanese Unexamined Patent Application Publication No. H07-142055). In order to obtain superior charge-discharge cycle characteristics, additive powder such as boron nitride having higher hardness than that of a current collector is contained in an active material layer of an anode containing an active material having lower hardness than that of the current collector (for example, see Japanese Unexamined Patent Application Publication No. H08-321301). In order to decrease an irreversible capacity, a nitride such as boron nitride is contained in a cathode mixture or the like (for example, see Japanese Unexamined Patent Application Publication No. H09-289011). In order to improve charge-discharge cycle characteristics and the like, a carbon/ceramics composite material such as a composite material of carbon and a boride is contained in a cathode mixture or the like (for example, see Japanese Unexamined Patent Application Publication No. H08-298121). In order to improve a discharge capacity at the time of discharging a large current, a lubricant agent layer such as hexagonal boron nitride is provided in an interface between an electrode and a separator (for example, see Japanese Unexamined Patent Application Publication No. 2002-260742).

In order to suppress increase of temperature in a battery at the time of disorder, boron nitride or the like is contained in a separator (for example, see Japanese Unexamined Patent Application Publication No. H11-086824). In order to secure safety at the time of abnormal heating, scale-like particles such as alumina are contained in a separator (for example, see Japanese Unexamined Patent Application Publication No. 2008-066094).

In addition thereto, in order to suppress lowering of a discharge capacity and increase of an irreversible capacity, in a step of manufacturing highly-graphitizable carbon powder, a boron compound is added to and mixed with carbon powder, the resultant mixture is graphitized, and subsequently, the graphitized carbon powder is subjected to alkali cleaning (for example, see Japanese Unexamined Patent Application Publication No. 2000-090928).

### SUMMARY

Although various studies have been made on safety of secondary batteries, sufficient safety has not been obtained. Therefore, there is room for improvement.

It is desirable to provide a secondary battery capable of obtaining superior safety.

According to an embodiment of the present technology, there is provided a secondary battery including: a cathode and an anode that are opposed to each other with a separator in between; and an electrolytic solution, wherein the cathode includes a cathode current collector and a cathode active material layer provided between the cathode current collector and the separator, the anode includes an anode current collector and an anode active material layer provided between the anode current collector and the separator, one or more of the cathode, the anode, and the separator includes a plurality of thermally-conductive particles in a region between the cathode current collector and the anode current collector, and heat conductivity of the thermally-conductive particles is larger in a second direction that intersects with a first direction, in which the cathode and the anode are opposed to each other, than in the first direction.

According to the secondary battery of the embodiment of the present technology, since one or more of the cathode, the anode, and the separator includes the foregoing plurality of thermally-conductive particles in the region between the cathode current collector and the anode current collector, superior safety is obtainable.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a cross-sectional view illustrating a configuration of a secondary battery (cylindrical-type) in an embodiment of the present technology.

FIG. 2 is a cross-sectional view illustrating an enlarged part of a spirally wound electrode body illustrated in FIG. 1.

FIG. 3 is a view explaining an orientation state of thermally-conductive particles.

FIG. 4 is a cross-sectional view illustrating another configuration of the spirally wound electrode body.

FIG. 5 is a view explaining another orientation state of the thermally-conductive particles.

FIG. 6 is a cross-sectional view illustrating still another configuration of the spirally wound electrode body.

FIG. 7 is a cross-sectional view illustrating still another configuration of the spirally wound electrode body.

FIG. 8 is a perspective view illustrating a configuration of another secondary battery (laminated-film-type) in the embodiment of the present technology.

FIG. 9 is a cross-sectional view taken along a line IX-IX of a spirally wound electrode body illustrated in FIG. 8.

FIG. 10 is a block diagram illustrating a configuration of an application example (a battery pack) of the secondary battery.

FIG. 11 is a block diagram illustrating a configuration of an application example (an electric vehicle) of the secondary battery.

FIG. 12 is a block diagram illustrating a configuration of an application example (an electric power storage system) of the secondary battery.

FIG. 13 is a block diagram illustrating a configuration of an application example (an electric power tool) of the secondary battery.

### DETAILED DESCRIPTION

An embodiment of the present technology will be described below in detail with reference to the drawings. The description will be given in the following order.

1. Secondary Battery
1-1. Lithium Ion Secondary Battery (Cylindrical-Type)
   1-1-1. Location Containing Thermally-Conductive Particles: Active Material Layer
   1-1-2. Location Containing Thermally-Conductive Particles: Covering Layer of Electrode
   1-1-3. Location Containing Thermally-Conductive Particles: Covering Layer of Separator
   1-1-4 Summary of Location Containing Thermally-Conductive Particles
1-2. Lithium Ion Secondary Battery (Laminated-Film-Type)
1-3. Lithium Metal Secondary Battery (Cylindrical-Type and Laminated-Film-Type)

2. Applications of Secondary Battery
2-1. Battery Pack
2-2. Electric Vehicle
2-3. Electric Power Storage System
2-4. Electric Power Tool

### [1. Secondary Battery]

### [1-1. Lithium Ion Secondary Battery (Cylindrical-Type)]

### [1-1-1. Location Containing Thermally-Conductive Particles: Active Material Layer]

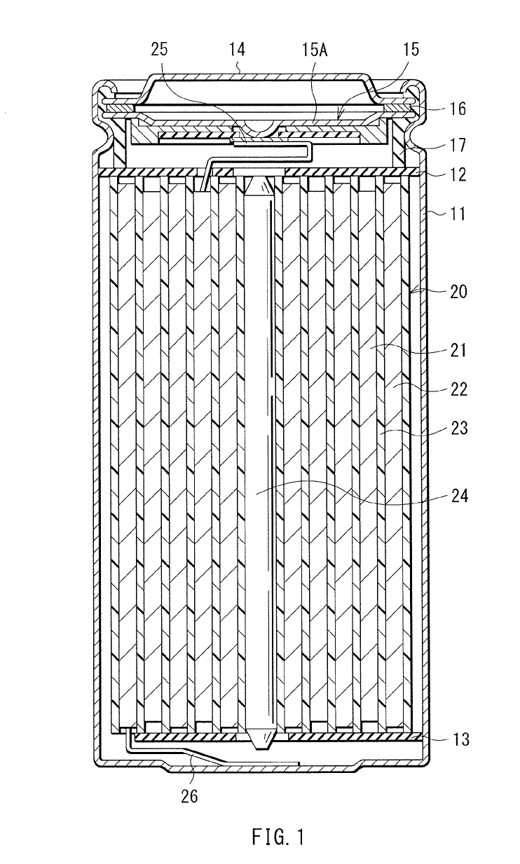

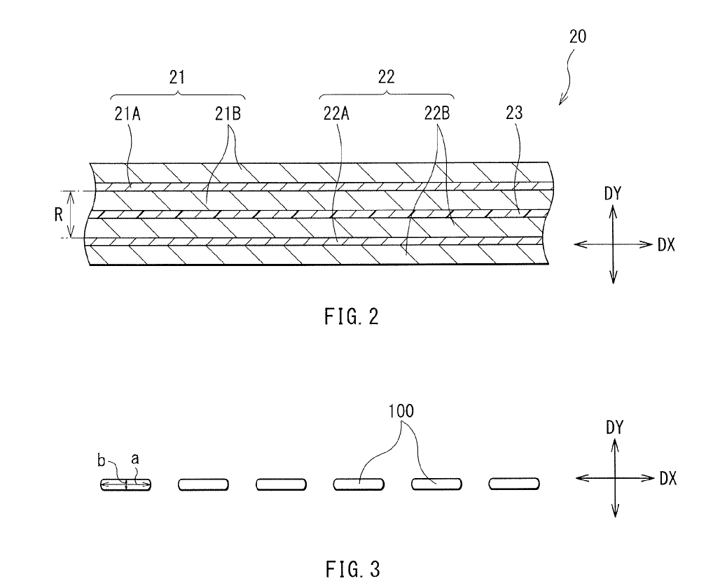

FIG. 1 and FIG. 2 illustrate cross-sectional configurations of a secondary battery in an embodiment of the present technology. FIG. 2 illustrates enlarged part of a spirally wound electrode body 20 illustrated in FIG. 1.

### [Whole Configuration of Secondary Battery]

The secondary battery described here is a lithium secondary battery (a lithium ion secondary battery) in which the capacity of an anode 22 is obtained by insertion and extraction of lithium (lithium ions) as an electrode reactant, and is, for example, a so-called cylindrical-type lithium secondary battery.

The secondary battery may contain, for example, the spirally wound electrode body 20 and a pair of insulating plates 12 and 13 inside a battery can 11 in the shape of a substantially hollow cylinder. The spirally wound electrode body 20 may be formed by, for example, laminating a cathode 21 and the anode 22 with a separator 23 in between, and spirally winding the resultant laminated body. The cathode 21 and the anode 22 are opposed to each other with the separator 23 in between.

The battery can 11 may have, for example, a hollow structure in which one end of the battery can 11 is closed and the other end of the battery can 11 is opened. The battery can 11 may be made, for example, of iron, aluminum, an alloy thereof, or the like. The surface of the battery can 11 may be plated with nickel or the like. The pair of insulating plates 12 and 13 is arranged to sandwich the spirally wound electrode body 20 in between, and to extend perpendicularly to the spirally wound periphery surface of the spirally wound electrode body 20.

At the open end of the battery can 11, a battery cover 14, a safety valve mechanism 15, and a positive temperature coefficient device (PTC device) 16 are attached by being swaged with a gasket 17. Thereby, the battery can 11 is hermetically sealed. The battery cover 14 may be made, for example, of a material similar to that of the battery can 11. The safety valve mechanism 15 and the PTC device 16 are provided inside the battery cover 14. The safety valve mechanism 15 is electrically connected to the battery cover 14 through the PTC device 16. In the safety valve mechanism 15, in the case where the internal pressure becomes a certain level or more by internal short circuit, external heating, or the like, a disk plate 15A inverts to cut electric connection between the battery cover 14 and the spirally wound electrode body 20. The PTC device 16 prevents abnormal heat generation resulting from a large current. As temperature rises, resistance of the PTC device 16 is increased accordingly. The gasket 17 may be made, for example, of an insulating material. The surface of the gasket 17 may be coated with asphalt or the like.

In the space of the center of the spirally wound electrode body 20, for example, a center pin 24 may be inserted. However, the center pin 24 is not necessarily included therein. For example, a cathode lead 25 made of an electrically-conductive material such as aluminum may be connected to the cathode 21. For example, an anode lead 26 made of an electrically-conductive material such as nickel may be connected to the anode 22. For example, the cathode lead 25 may be welded to the safety valve mechanism 15, and may be electrically connected to the battery cover 14. For example, the anode lead 26 may be welded to the battery can 11, and may be electrically connected to the battery can 11.

### [Cathode]

The cathode 21 has a cathode active material layer 21B on a single surface or both surfaces of a cathode current collector 21A. The cathode current collector 21A may be made, for example, of one or more of electrically-conductive materials such as aluminum (Al), nickel (Ni), and stainless steel. In particular, the cathode current collector 21A may preferably contain aluminum as a constituent element, and may be more preferably formed of aluminum, since thereby, superior electric conductivity and the like are obtained.

The cathode active material layer 21B contains, as cathode active materials, one or more of cathode materials capable of inserting and extracting lithium ions. The cathode active material layer 21B may further contain other materials such as a cathode binder and a cathode electric conductor.

The cathode material may be preferably a lithium-containing compound, since thereby, high energy density is obtained. Examples of the lithium-containing compound may include a lithium-transition-metal composite oxide and a lithium-transition-metal-phosphate compound. The lithium-transition-metal composite oxide is a compound (an oxide) containing lithium (Li), one or more transition metal elements, and oxygen (O) as constituent elements. The lithium-transition-metal-phosphate compound is a phosphate compound containing Li and one or more transition metal elements as constituent elements. In particular, the transition metal element may be preferably one or more of nickel, cobalt (Co), manganese (Mn), iron (Fe), and the like, may be more preferably one or more of Ni, Co, and Mn, and may be further more preferably Ni. A ratio of Ni in the transition metal elements is not particularly limited, and in particular, may be preferably 50 atomic % or more, since thereby, a higher voltage is obtained. The chemical formula thereof may be expressed, for example, by LiₓM1O₂ or Li_{y}M2PO₄. In the formulas, M1 and M2 represent one or more transition metal elements. Values of x and y vary according to the charge and discharge state, and may be, for example, in the range of 0.05≦x≦1.10 and 0.05≦y≦1.10.

Examples of the lithium-transition-metal composite oxide may include LiCoO₂, LiNiO₂, and a lithium-nickel-based composite oxide represented by the following Formula (1). In particular, LiNiO₂ containing nickel as a transition metal element may be preferable. Examples of the lithium-transition-metal-phosphate compound may include LiFePO₄ and LiFe₁₋ᵤMnᵤPO₄ (u<1), since thereby, a high battery capacity is obtained and superior cycle characteristics and the like are obtained as well.

LiNi_{1-z}M_{z}O₂ (1)

In Formula (1), M is one or more of Co, Mn, Fe, Al, V, Sn, Mg, Ti, Sr, Ca, Zr, Mo, Tc, Ru, Ta, W, Re, Yb, Cu, Zn, Ba, B, Cr, Si, Ga, P, Sb, and Nb; and z satisfies 0.005<z<0.5.

In addition thereto, the cathode material may be, for example, one or more of an oxide, a disulfide, a chalcogenide, an electrically-conductive polymer, and the like. Examples of the oxide may include titanium oxide, vanadium oxide, and manganese dioxide. Examples of the disulfide may include titanium disulfide and molybdenum sulfide. Examples of the chalcogenide may include niobium selenide. Examples of the electrically-conductive polymer may include sulfur, polyaniline, and polythiophene. However, the cathode material is not limited to one of the foregoing materials, and may be other material.

Examples of the cathode binder may include one or more of synthetic rubbers, polymer materials, and the like. Examples of the synthetic rubber may include a styrene-butadiene-based rubber, a fluorine-based rubber, and ethylene propylene diene. Examples of the polymer material may include polyvinylidene fluoride and polyimide.

Examples of the cathode electric conductor may include one or more of carbon materials and the like. Examples of the carbon materials may include graphite, carbon black, acetylene black, and Ketjen black. It is to be noted that the cathode electric conductor may be a metal material, an electrically-conductive polymer, or the like as long as the material has electric conductivity.

### [Anode]

The anode 22 has an anode active material layer 22B on a single surface or both surfaces of an anode current collector 22A.

The anode current collector 22A may be made, for example, of one or more of electrically-conductive materials such as copper (Cu), nickel, and stainless steel. In particular, the anode current collector 22A may preferably contain copper as a constituent element, and may be more preferably formed of copper, since thereby, superior electric conductivity and the like are obtained.

The surface of the anode current collector 22A may be preferably roughened. Thereby, due to a so-called anchor effect, adhesibility of the anode active material layer 22B with respect to the anode current collector 22A is improved. In this case, it is enough that the surface of the anode current collector 22A in a region opposed to the anode active material layer 22B is roughened at minimum. Examples of roughening methods may include a method of forming fine particles by utilizing electrolytic treatment. The electrolytic treatment is a method of providing concavity and convexity on the surface of the anode current collector 22A by forming fine particles on the surface of the anode current collector 22A in an electrolytic bath with the use of an electrolytic method. A copper foil fabricated by an electrolytic method is generally called “electrolytic copper foil.”

The anode active material layer 22B contains one or more of anode materials capable of inserting and extracting lithium ions as anode active materials, and may further contain other materials such as an anode binder and an anode electric conductor. Details of the anode binder and the anode electric conductor may be, for example, similar to those of the cathode binder and the cathode electric conductor.

However, the chargeable capacity of the anode material may be preferably larger than the discharge capacity of the cathode 21 in order to prevent lithium metal from being unintentionally precipitated on the anode 22 in the middle of charge. That is, the electrochemical equivalent of the anode material capable of inserting and extracting lithium ions may be preferably larger than the electrochemical equivalent of the cathode 21.

The anode material may be, for example, one or more of carbon materials. In the carbon materials, crystal structure change at the time of insertion and extraction of lithium ions is extremely small. Therefore, the carbon materials provide high energy density, superior cycle characteristics, and the like. Further, the carbon materials function as anode electric conductors as well. Examples of the carbon materials may include graphitizable carbon, non-graphitizable carbon in which the spacing of (002) plane is equal to or greater than 0.37 nm, and graphite in which the spacing of (002) plane is equal to or smaller than 0.34 nm. More specifically, examples of the carbon materials may include pyrolytic carbons, cokes, glassy carbon fiber, an organic polymer compound fired body, activated carbon, and carbon blacks. Examples of the cokes may include pitch coke, needle coke, and petroleum coke. The organic polymer compound fired body is obtained by firing (carbonizing) a polymer compound such as a phenol resin and a furan resin at appropriate temperature. In addition thereto, examples of the carbon materials may include low crystalline carbon and amorphous carbon that are heat-treated at temperature of about 1000 deg C or less. It is to be noted that the shape of any of the carbon materials may be any of a fibrous shape, a spherical shape, a granular shape, and a scale-like shape.

Further, the anode material may be, for example, a material (metal-based material) containing one or more of metal elements and metalloid elements as constituent elements, since thereby, higher energy density is obtained. Such a metal-based material may be any of a simple substance, an alloy, and a compound, may be two or more thereof, or may be a material having one or more phases thereof in part or all thereof. It is to be noted that “alloy” includes a material containing one or more metal elements and one or more metalloid elements, in addition to a material configured of two or more metal elements. Further, the “alloy” may contain a non-metallic element. Examples of the structure thereof may include a solid solution, a eutectic crystal (eutectic mixture), an intermetallic compound, and a structure in which two or more thereof coexist.

Examples of the foregoing metal elements and the foregoing metalloid elements may include one or more of metal elements and metalloid elements that are capable of forming an alloy with lithium. Specific examples thereof may include Mg, B, Al, Ga, In, Si, Ge, Sn, Pb, Bi, Cd, Ag, Zn, Hf, Zr, Y, Pd, and Pt. In particular, Si, Sn, or both may be preferable. Si and Sn have a superior ability of inserting and extracting lithium ions, and therefore, provide high energy density.

A material containing Si, Sn, or both as constituent elements may be any of a simple substance, an alloy, and a compound of Si or Sn, may be two or more thereof, or may be a material having one or more phases thereof in part or all thereof. It is to be noted that, the term “simple substance” merely refers to a general simple substance (a small amount of impurity may be therein contained), and does not necessarily refer to a purity 100% simple substance.

The alloys of Si may contain, for example, one or more of elements such as Sn, Ni, Cu, Fe, Co, Mn, Zn, In, Ag, Ti, Ge, Bi, Sb, and Cr as constituent elements other than Si. The compounds of Si may contain, for example, one or more of C, 0, and the like as constituent elements other than Si. It is to be noted that, for example, the compounds of Si may contain one or more of the elements described for the alloys of Si as constituent elements other than Si.

Examples of the alloys of Si and the compounds of Si may include SiB₄, SiB₆, Mg₂Si, Ni₂Si, TiSi₂, MoSi₂, CoSi₂, NiSi, CaSi₂, CrSi₂, Cu₅Si, FeSi₂, MnSi₂, NbSi, TaSi₂, VSi₂, WSi₂, ZnSi₂, SiC, Si₃N₄, Si₂N₂O, SiOᵥ (0<v≦2), and LiSiO. It is to be noted that v in SiOᵥ may be in the range of 0.2<v<1.4.

The alloys of Sn may contain, for example, one or more of elements such as Si, Ni, Cu, Fe, Co, Mn, Zn, In, Ag, Ti, Ge, Bi, Sb, and Cr as constituent elements other than Sn. The compounds of Sn may contain, for example, one or more of elements such as C and O as constituent elements other than Sn. It is to be noted that the compounds of Sn may contain, for example, one or more of elements described for the alloys of Sn as constituent elements other than Sn. Examples of the alloys of Sn and the compounds of Sn may include SnO_{w} (0<w≦2), SnSiO₃, LiSnO, and Mg₂Sn.

Further, as a material containing Sn, for example, a material containing a second constituent element and a third constituent element in addition to Sn as a first constituent element may be preferable. Examples of the second constituent element may include one or more of elements such as Co, Fe, Mg, Ti, V, Cr, Mn, Ni, Cu, Zn, Ga, Zr, Nb, Mo, Ag, In, Ce, Hf, Ta, W, Bi, and Si. Examples of the third constituent element may include one or more of B, C, Al, P, and the like. In the case where the second constituent element and the third constituent element are contained, a high battery capacity, superior cycle characteristics, and the like are obtained.

In particular, a material (an SnCoC-containing material) containing Sn, Co, and C as constituent elements may be preferable. As a composition of the SnCoC-containing material, for example, the C content may be from 9.9 mass % to 29.7 mass % both inclusive, and the ratio of Sn and Co contents (Co/(Sn+Co)) may be from 20 mass % to 70 mass % both inclusive, since thereby, high energy density is obtained.

It may be preferable that the SnCoC-containing material have a phase containing Sn, Co, and C. Such a phase may be preferably low-crystalline or amorphous. The phase is a reaction phase capable of reacting with Li. Therefore, due to existence of the reaction phase, superior characteristics are obtained. The half bandwidth of the diffraction peak obtained by X-ray diffraction of the phase may be preferably equal to or greater than 1 deg based on diffraction angle of 20 in the case where CuKα ray is used as a specific X ray, and the insertion rate is 1 deg/min. Thereby, lithium ions are more smoothly inserted and extracted, and reactivity with the electrolytic solution is decreased. It is to be noted that, in some cases, the SnCoC-containing material includes a phase containing a simple substance or part of the respective constituent elements in addition to the low-crystalline phase or the amorphous phase.

Whether or not the diffraction peak obtained by the X-ray diffraction corresponds to the reaction phase capable of reacting with Li is allowed to be easily determined by comparison between X-ray diffraction charts before and after electrochemical reaction with Li. For example, if the position of the diffraction peak after electrochemical reaction with Li is changed from the position of the diffraction peak before the electrochemical reaction with Li, the obtained diffraction peak corresponds to the reaction phase capable of reacting with Li. In this case, for example, the diffraction peak of the low crystalline reaction phase or the amorphous reaction phase is seen in the range of 2θ=from 20 deg to 50 deg both inclusive. Such a reaction phase may have, for example, the foregoing respective constituent elements, and the low crystalline or amorphous structure thereof possibly results from existence of C mainly.

In the SnCoC-containing material, part or all of C as a constituent element may be preferably bonded to a metal element or a metalloid element as other constituent element, since cohesion or crystallization of Sn and/or the like is suppressed thereby. The bonding state of elements is allowed to be checked with the use, for example, of X-ray photoelectron spectroscopy (XPS). In a commercially available device, for example, as a soft X ray, Al—Kα ray, Mg—Kα ray, or the like may be used. In the case where part or all of C are bonded to a metal element, a metalloid element, or the like, the peak of a synthetic wave of is orbit of C (C1s) is shown in a region lower than 284.5 eV. It is to be noted that in the device, energy calibration is made so that the peak of 4f orbit of Au atom (Au4f) is obtained in 84.0 eV. At this time, in general, since surface contamination carbon exists on the material surface, the peak of C1s of the surface contamination carbon is regarded as 284.8 eV, which is used as the energy standard. In XPS measurement, the waveform of the peak of C1s is obtained as a form including the peak of the surface contamination carbon and the peak of carbon in the SnCoC-containing material. Therefore, for example, analysis may be made with the use of commercially available software to isolate both peaks from each other. In the waveform analysis, the position of the main peak existing on the lowest bound energy side is the energy standard (284.8 eV).

It is to be noted that the SnCoC-containing material is not limited to the material configured of only Sn, Co, and C (SnCoC) as constituent elements. That is, the SnCoC-containing material may further contain, for example, one or more of Si, Fe, Ni, Cr, In, Nb, Ge, Ti, Mo, Al, P, Ga, Bi, and the like as constituent elements as necessary.

In addition to the SnCoC-containing material, a material containing Sn, Co, Fe, and C as constituent elements (an SnCoFeC-containing material) may be also preferable. The composition of the SnCoFeC-containing material may be arbitrarily set. For example, the composition in which the Fe content may be set small is as follows. That is, the C content may be from 9.9 mass % to 29.7 mass % both inclusive, the Fe content may be from 0.3 mass % to 5.9 mass % both inclusive, and the ratio (Co/(Sn+Co)) of contents of Sn and Co may be from 30 mass % to 70 mass % both inclusive. Further, the composition in which the Fe content is set large is as follows. That is, the C content may be from 11.9 mass % to 29.7 mass % both inclusive, the ratio ((Co+Fe)/(Sn+Co+Fe)) of contents of Sn, Co, and Fe may be from 26.4 mass % to 48.5 mass % both inclusive, and the ratio (Co/(Co+Fe)) of contents of Co and Fe may be from 9.9 mass % to 79.5 mass % both inclusive. In such a composition range, high energy density is obtained. It is to be noted that the physical properties (such as half bandwidth) of the SnCoFeC-containing material are similar to the physical properties of the foregoing SnCoC-containing material.

In addition thereto, the anode material may be, for example, one or more of metal oxides, polymer compounds, and the like. Examples of the metal oxides may include iron oxide, ruthenium oxide, and molybdenum oxide. Examples of the polymer compounds may include polyacetylene, polyaniline, and polypyrrole. However, the anode material is not limited to any of the foregoing materials, and may be other material.

The anode active material layer 22B may be formed, for example, by one or more of a coating method, a vapor-phase deposition method, a liquid-phase deposition method, a spraying method, a firing method (sintering method), and the like. The coating method is a method in which, for example, after a particulate (powder) anode active material is mixed with an anode binder and/or the like, the resultant mixture is dispersed in a solvent such as an organic solvent, and the anode current collector 22A is coated with the resultant. Examples of the vapor-phase deposition method may include a physical deposition method and a chemical deposition method. More specifically, examples thereof may include a vacuum evaporation method, a sputtering method, an ion plating method, a laser ablation method, a thermal chemical vapor deposition method, a chemical vapor deposition (CVD) method, and a plasma chemical vapor deposition method. Examples of the liquid-phase deposition method may include an electrolytic plating method and an electroless plating method. The spraying method is a method in which an anode active material in a fused state or a semi-fused state is sprayed to the anode current collector 22A. The firing method is a method in which after a coating film is formed on the anode current collector 22A with the use, for example, of a coating method, heat treatment is performed on the coating film at temperature higher than the melting point of the anode binder and/or the like. Examples of the firing method may include an atmosphere firing method, a reactive firing method, and a hot press firing method.

In the secondary battery, as described above, in order to prevent lithium metal from being unintentionally precipitated on the anode 22 in the middle of charge, the electrochemical equivalent of the anode material capable of inserting and extracting lithium ions is larger than the electrochemical equivalent of the cathode. Further, in the case where the open circuit voltage (that is, a battery voltage) at the time of completely-charged state is equal to or greater than 4.25 V, the extraction amount of lithium ions per unit mass is larger than that in the case where the open circuit voltage is 4.20 V even if the same cathode active material is used. Therefore, amounts of the cathode active material and the anode active material are adjusted accordingly. Thereby, high energy density is obtainable.

### [Separator]

The separator 23 separates the cathode 21 from the anode 22, and passes lithium ions while preventing current short circuit resulting from contact of both electrodes. The separator 23 may be, for example, a porous film made of one or more of a synthetic resin, ceramics, and the like. The separator 23 may be a laminated film in which two or more types of porous films are laminated. Examples of the synthetic resin may include polytetrafluoroethylene, polypropylene, and polyethylene.

In particular, the separator 23 may include, for example, a base material layer formed of the foregoing porous film and a polymer compound layer provided on a single surface or both surfaces of the base material layer. Thereby, adhesibility of the separator 23 with respect to the cathode 21 and the anode 22 is improved, and therefore, skewness of the spirally wound electrode body 20 is suppressed. Thereby, a decomposition reaction of the electrolytic solution is suppressed, and liquid leakage of the electrolytic solution with which the base material layer is impregnated is suppressed. Accordingly, even if charge and discharge are repeated, the resistance of the secondary battery is less likely to be increased, and battery swollenness is suppressed.

The polymer compound layer may contain, for example, a polymer material such as polyvinylidene fluoride, since such a polymer material has a superior physical strength and is electrochemically stable. However, the polymer material may be a material other than polyvinylidene fluoride. In the case of forming the polymer compound layer, for example, after a solution in which the polymer material is dissolved is prepared, the base material layer is coated with the solution, and the resultant is subsequently dried. Alternatively, the base material layer may be soaked in the solution and may be subsequently dried.

### [Electrolytic Solution]

The separator 23 is impregnated with an electrolytic solution as a liquid electrolyte. The electrolytic solution contains a solvent and an electrolyte salt, and may further contain other materials such as an additive as necessary.

The solvent contains one or more of non-aqueous solvents such as an organic solvent.

Examples of the non-aqueous solvents may include a cyclic ester carbonate, a chain ester carbonate, lactone, a chain carboxylic ester, and nitrile, since thereby, a superior battery capacity, superior cycle characteristics, superior conservation characteristics, and the like are obtained. Examples of the cyclic ester carbonate may include ethylene carbonate, propylene carbonate, and butylene carbonate. Examples of the chain ester carbonate may include dimethyl carbonate, diethyl carbonate, ethyl methyl carbonate, and methylpropyl carbonate. Examples of the lactone may include γ-butyrolactone and γ-valerolactone. Examples of the carboxylic ester may include methyl acetate, ethyl acetate, methyl propionate, ethyl propionate, methyl butyrate, methyl isobutyrate, methyl trimethylacetate, and ethyl trimethylacetate. Examples of the nitrile may include acetonitrile, glutaronitrile, adiponitrile, methoxyacetonitrile, and 3-methoxypropionitrile.

In addition thereto, examples of the non-aqueous solvents may include 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, N,N-dimethylformamide, N-methylpyrrolidinone, N-methyloxazolidinone, N,N′-dimethylimidazolidinone, nitromethane, nitroethane, sulfolane, trimethyl phosphate, and dimethyl sulfoxide. Thereby, a similar advantage is obtained.

In particular, one or more of ethylene carbonate, propylene carbonate, dimethyl carbonate, diethyl carbonate, and ethyl methyl carbonate may be preferable, since thereby, a superior battery capacity, superior cycle characteristics, superior conservation characteristics, and the like are obtained. In this case, a combination of a high viscosity (high dielectric constant) solvent (for example, specific dielectric constant ∈≧30) such as ethylene carbonate and propylene carbonate and a low viscosity solvent (for example, viscosity≦1 mPa·s) such as dimethyl carbonate, ethylmethyl carbonate, and diethyl carbonate may be more preferable. One reason for this is that, in this case, the dissociation property of the electrolyte salt and ion mobility are improved.

In particular, the solvent may preferably contain one or more of unsaturated cyclic ester carbonates, since thereby, a stable protective film is formed mainly on the surface of the anode 22 at the time of charge and discharge, and therefore, a decomposition reaction of the electrolytic solution is suppressed. The foregoing “unsaturated cyclic ester carbonate” refers to a cyclic ester carbonate having one or more unsaturated carbon bonds (carbon-carbon double bonds). Specific examples of the unsaturated cyclic ester carbonate may include vinylene carbonate, vinylethylene carbonate, and methyleneethylene carbonate. However, examples thereof may include other materials. The content of the unsaturated cyclic ester carbonate in the solvent is not particularly limited, and may be, for example, from 0.01 wt % to 10 wt % both inclusive.

Further, the solvent may preferably contain one or more of halogenated ester carbonates, since thereby, a stable protective film is formed mainly on the surface of the anode 22 at the time of charge and discharge, and therefore, a decomposition reaction of the electrolytic solution is suppressed. The foregoing “halogenated ester carbonate refers to a cyclic ester carbonate or a chain ester carbonate containing one or more halogens as constituent elements. Examples of the cyclic halogenated ester carbonate may include 4-fluoro-1,3-dioxolane-2-one, and 4,5-difluoro-1,3-dioxolane-2-one. However, examples thereof may include other materials. Examples of the chain halogenated ester carbonate may include fluoromethyl methyl carbonate, bis(fluoromethyl) carbonate, and difluoromethyl methyl carbonate. However, examples thereof may include other materials. The content of the halogenated ester carbonate in the solvent is not particularly limited, and may be, for example, from 0.01 wt % to 50 wt % both inclusive.

Further, the solvent may preferably contain a sultone (a cyclic sulfonic ester), since the chemical stability of the electrolytic solution is more improved thereby. Examples of the sultone may include propane sultone and propene sultone. Examples thereof may include other material. The sultone content in the solvent is not particularly limited, and may be, for example, from 0.5 wt % to 5 wt % both inclusive.

Further, the solvent may preferably contain an acid anhydride since the chemical stability of the electrolytic solution is thereby further improved. Examples of the acid anhydride may include a carboxylic anhydride, a disulfonic anhydride, and a carboxylic acid sulfonic acid anhydride. However, examples thereof may include other materials. Examples of the carboxylic anhydride may include a succinic anhydride, a glutaric anhydride, and a maleic anhydride. However, examples thereof may include other materials. Examples of the disulfonic anhydride may include an ethane disulfonic anhydride and a propane disulfonic anhydride. However, examples thereof may include other materials. Examples of the carboxylic acid sulfonic acid anhydride may include a sulfobenzoic anhydride, a sulfopropionic anhydride, and a sulfobutyric anhydride. However, examples thereof may include other materials. The content of the acid anhydride in the solvent is not particularly limited, and may be, for example, from 0.5 wt % to 5 wt % both inclusive.

The electrolyte salt may contain, for example, one or more of lithium salts. However, the electrolyte salt may contain, for example, a salt other than the lithium salt (such as a light metal salt other than the lithium salt).

Examples of the lithium salts may include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethane sulfonate (LiCF₃SO₃), lithium tetrachloroaluminate (LiAlCl₄), dilithium hexafluorosilicate (Li₂SiF₆), lithium chloride (LiCl), and lithium bromide (LiBr). Thereby, a superior battery capacity, superior cycle characteristics, superior conservation characteristics, and the like are obtained. However, specific examples of the lithium salts are not limited to the foregoing compounds, and may include other compounds.

In particular, one or more of LiPF₆, LiBF₄, LiClO₄, and LiAsF₆ may be preferable, and LiPF₆ may be more preferable, since thereby, the internal resistance is lowered, and therefore, a higher effect is obtained.

The content of the electrolyte salt may be preferably from 0.3 mol/kg to 3.0 mol/kg both inclusive with respect to the solvent, since high ion conductivity is obtained thereby.

### [Thermally-Conductive Particles]

As illustrated in FIG. 2, in a region R between the cathode current collector 21A and the anode current collector 22A, one or more of the cathode 21, the anode 22, and the separator 23 contain a plurality of thermally-conductive particles.

The thermally-conductive particles have anisotropic heat conductivity. Specifically, heat conductivity of the thermally-conductive particles is larger in a direction (a crossing direction DX as a second direction) that intersects with a direction (an opposing direction DY as a first direction) in which the cathode 21 and the anode 22 are opposed to each other than in the opposing direction DY. It is to be noted that in FIG. 2, the term “opposing direction DY” refers to a vertical direction, and the term “crossing direction DX” refers to a horizontal direction.

One of the reasons why the foregoing cathode 21 and/or the like contains the plurality of thermally-conductive particles is that, in this case, ignition, breakage, and the like caused by self-heating of the secondary battery are suppressed, and thereby, safety is secured.

More specifically, in the case where the secondary battery generates heat caused by external heating, internal short circuit, and/or the like, the cathode 21, the anode 22, the electrolytic solution and the like are heated, and therefore, the secondary battery becomes unstable due to so-called self-heating. In this case, in the case where oxygen (O₂) is generated from the cathode 21 as temperature in the battery increases, heat generation is accelerated due to a reaction between the oxygen and the electrolytic solution. Further, heat generation is also accelerated due to a direct reaction between the foregoing oxygen and the anode active material. In particular, in the case where the anode active material is a high-reactive metal-based material, the oxygen easily reacts with the anode active material, and therefore, significant heat is generated in the anode 22. Thereby, the secondary battery takes fire, or is broken.

In particular, in the case where heat generation proceeds to temperature exceeding the melting point of the anode current collector 22A, excessive heat is generated in the anode 22. When the excessive heat is conducted from the anode 22 to the cathode 21, so-called thermal runway occurs in the cathode 21 since the cathode current collector 21A and the cathode active material layer 21B are heated at high temperature. In this case, in the case where the cathode current collector 21A contains Al as a constituent element, thermite reaction occurs in the cathode current collector 21A and the cathode active material layer 21B. Therefore, in the secondary battery, heat is explosively generated in a state of chain reaction. Thereby, in addition to ignition of the secondary battery, the secondary battery is severely broken to the degree that the external appearance is deformed.

In terms thereof, in the case where the plurality of thermally-conductive particles exist in the foregoing region R, heat generated in the anode 22 is less likely to be conducted to the cathode 21, and therefore, safety is improved.

More specifically, as described above, the heat conductivity of the thermally-conductive particles is larger in the crossing direction DX than in the opposing direction DY, and therefore, the thermally-conductive particles are characterized in that heat is easily conducted in the crossing direction DX than in the opposing direction DY. Therefore, in the case where heat generated in the anode 22 reaches the thermally-conductive particles before the heat reaches the cathode 21, the heat is induced to the crossing direction DX by the thermally-conductive particles, and is less likely to be conducted to the cathode 21 existing in the opposing direction DY. Thereby, compared to in a case where the thermally-conductive particles are not used, heat quantity conducted from the anode 22 to the cathode 21 is decreased. Therefore, even if self-heating of the secondary battery is generated, there is a low possibility of ignition and breakage. Accordingly, since temperature of the secondary battery is less likely to be increased excessively, safety is allowed to be secured.

Locations containing the thermally-conductive particles are not particularly limited, as long as such locations are one or more of the components of the secondary battery existing in the region R. That is, the thermally-conductive particles may be contained in only one of the cathode 21, the anode 22, and the separator 23, may be contained in any combination of two thereof, or may be contained in all thereof. One reason for this is that, as long as the thermally-conductive particles exist in the region R, the foregoing advantages are obtained without depending on locations containing the thermally-conductive particles.

In particular, the thermally-conductive particles may be more preferably contained in two of the cathode 21, the anode 22, and the separator 23 than in one thereof, and may be further more preferably contained in all thereof. One reason for this is that, in this case, heat generated in the anode 22 is further easily induced to the crossing direction DX, and therefore, heat quantity reaching the cathode 21 is further decreased.

It is to be noted that, in the case where the thermally-conductive particles are contained in only one of the cathode 21, the anode 22, and the separator 23, the thermally-conductive particles may be preferably contained in the anode 22. One reason for this is that, in this case, heat is induced to the crossing direction DX in the anode 22 itself as a main heat generation source that may induct self-heating, and therefore, heat is further less likely to be conducted from the anode 22 to the cathode 21.

In this example, the location containing the thermally-conductive particles may be, for example, the active material layer of the cathode 21 or the active material layer of the anode 22. More specifically, for example, in the anode 22, the active material layer (the anode active material layer 22B) located between the anode current collector 22A and the separator 23 contains the plurality of thermally-conductive particles. That is, the plurality of thermally-conductive particles are contained in the anode active material layer 22B together with the foregoing anode active material and the like.

The shape of the thermally-conductive particles is not particularly limited as long as the heat conductivity thereof is larger in the crossing direction DX than in the opposing direction DY. That is, the shape of the thermally-conductive particles may be a spherical shape, a plate-like shape, or other shape. The term “plate-like shape” refers to any flat shape generally, and is a concept including a so-called a planular shape and a scale-like shape.

In particular, the shape of the thermally-conductive particles may be preferably a shape in which the length is larger than the thickness, and more specifically, may be more preferably a plate-like shape. One reason for this is that, in this case, due to the shape anisotropy of the thermally-conductive particles, a difference of heat conductivity is easily made between in the opposing direction DY and in the crossing direction DX.

FIG. 3 is a view for explaining an orientation state of thermally-conductive particles 100. The shape of the thermally-conductive particles 100 may be, for example, a plate-like shape having a long axis a and a short axis b. The dimension (the length) of the long axis a is larger than the dimension (the thickness) of the short axis b. In the anode active material layer 22B, part or all of the plurality of thermally-conductive particles 100 may be preferably oriented so that a length direction (a direction of the long axis a) is oriented to the crossing direction DX. One reason for this is that, in this case, due to the shape anisotropy of the thermally-conductive particles 100, heat conductivity is larger in the crossing direction DX corresponding to the direction of the long axis a than in the opposing direction DY corresponding to the short axis b.

It is to be noted that, in the case illustrated in FIG. 3, the direction of the long axis a is not necessarily in parallel with the crossing direction DX, and the direction of the long axis a may be slightly slanted off the crossing direction DX. The case in which the long axis a is slightly slanted off the crossing direction DX may refer to, for example, a case in which an angle between the direction of the long axis a and the crossing direction DX is less than 45 deg.

Description will be given of the thermally-conductive particles referring to FIG. 2 again. Distribution (distribution in the layer) of the thermally-conductive particles in the anode active material layer 22B is not particularly limited. That is, the content of the thermally-conductive particles in the anode active material layer 22B may be uniform or may be non-uniform in a thickness direction of the anode active material layer 22B. In the case where the content is non-uniform, the content may be higher on the side closer to the anode current collector 22A than on the side farther from the anode current collector 22A. Alternatively, the content may be smaller on the side closer to the anode current collector 22A than on the side farther from the anode current collector 22A.

In particular, the content of the thermally-conductive particles in the anode active material layer 22B may be preferably higher on the side closer to the anode current collector 22A than on the side farther from the anode current collector 22A. One reason for this is that, in the anode active material layer 22B, a large amount of the thermally-conductive particles exist in a region closer to the anode current collector 22A. Thereby, oxygen generated from the cathode 21 less likely to reach (is less likely to be in contact with) the anode current collector 22A, and heat generated in the anode active material layer 22B easily transfers to the anode current collector 22A. In order to obtain a state that the content of the thermally-conductive particles in the anode active material layer 22B is higher on the side closer to the anode current collector 22A than on the side farther from the anode current collector 22A, for example, the anode active material layer 22B may be configured of two layers. In this case, the content of the thermally-conductive particles in the lower layer (the layer on the side closer to the anode current collector 22A) may be higher than the content of the thermally-conductive particles in the upper layer (the layer on the side farther from the anode current collector 22A). It goes without saying that the number of layers of the anode active material layer 22B is not limited to two, but may be three or more.

Types of materials of the thermally-conductive particles are not particularly limited, as long as the thermally-conductive particles contain one or more of materials in which heat conductivity is larger in the crossing direction DX than in the opposing direction DY. That is, the thermally-conductive particles may contain an oxide, may contain a non-oxide, or may contain both thereof. Examples of the non-oxide may include a carbide and a nitride.

In particular, the thermally-conductive particles may preferably contain fine ceramics, since thereby, superior physical strength and superior chemical stability are obtained. Examples of the fine ceramics may include aluminum oxide (Al₂O₃), zirconia (ZrO₂), silicon oxide (SiO₂), silicon carbide (SiC), silicon nitride (Si₃N₄), aluminum nitride (AlN), and boron nitride (BN).

In particular, it may be preferable that the fine ceramics does not contain oxygen as a constituent element, that is, be a non-oxide. One reason for this is that, in this case, even if temperature of the secondary battery is increased due to thermal runaway and/or the like, oxygen gas that facilitates a side reaction is not generated from the thermally-conductive particles. Accordingly, the fine ceramics may be preferably one of silicon carbide, silicon nitride, aluminum nitride, boron nitride (BN), and the like, and may be more preferably boron nitride since thereby, superior anisotropy in heat conductivity is obtained in addition to superior physical strength and superior chemical stability.

Although the melting point of the thermally-conductive particles is not particularly limited, in particular, the melting point of the thermally-conductive particles may be preferably higher than the melting point of the anode current collector 22A. One reason for this is that, in this case, even if temperature of the secondary battery at the time of heat generation reaches the melting point of the anode current collector 22A, heat is induced by the thermally-conductive particles as described above. Accordingly, for example, in the case where the anode current collector 22A contains copper as a constituent element, the thermally-conductive particles may preferably contain boron nitride.

It is to be noted that in the case where the thermally-conductive particles are contained in the anode active material layer 22B together with the anode active material, a ratio G2/G1 between a weight G1 of the anode active material and a weight G2 of the thermally-conductive particles is not particularly limited. However, in particular, the ratio G2/G1 may be preferably from 3.1 to 31 both inclusive, since thereby, even if self-heating of the secondary battery is generated, temperature is further less likely to be increased, and therefore, safety is further improved.

### [Operation of Secondary Battery]

In the secondary battery, for example, lithium ions extracted from the cathode 21 are inserted in the anode 22 through the electrolytic solution at the time of charge, and lithium ions extracted from the anode 22 are inserted in the cathode 21 through the electrolytic solution at the time of discharge.

### [Method of Manufacturing Secondary Battery]

The secondary battery may be manufactured, for example, by the following procedure.

First, the cathode 21 is fabricated. In this example, a cathode active material is mixed with a cathode binder, a cathode electric conductor, and the like to prepare a cathode mixture. Subsequently, the cathode mixture is dispersed in an organic solvent or the like to obtain paste cathode mixture slurry. Subsequently, both surfaces of the cathode current collector 21A are coated with the cathode mixture slurry, and the cathode mixture slurry is dried to form the cathode active material layer 21B. Subsequently, the cathode active material layer 21B may be compression-molded with the use of a roll pressing machine and/or the like. In this case, compression-molding may be performed while heating the cathode active material layer 21B, or compression-molding may be repeated several times.

Further, the anode 22 is fabricated by a procedure similar to that of the cathode 21 described above. In this example, an anode active material is mixed with an anode binder, an anode electric conductor, and the like to prepare an anode mixture, and the anode mixture is subsequently dispersed in an organic solvent or the like to form paste anode mixture slurry. It is to be noted that in the case where the thermally-conductive particles are contained in the anode active material layer 22B of the anode 22, the thermally-conductive particles are added to the foregoing anode mixture or the foregoing anode mixture slurry. Subsequently, both surfaces of the anode current collector 22A are coated with the anode mixture slurry, and the anode mixture slurry is dried to form the anode active material layer 22B. Thereafter, the anode active material layer 22B is compression-molded as necessary.

Finally, the secondary battery is assembled with the use of the cathode 21 and the anode 22. In this example, the cathode lead 25 is attached to the cathode current collector 21A with the use of a welding method and/or the like, and the anode lead 26 is attached to the anode current collector 22A with the use of a welding method and/or the like. Subsequently, the cathode 21 and the anode 22 are layered with the separator 23 in between and are spirally wound, and thereby, the spirally wound electrode body 20 is fabricated. Thereafter, the center pin 24 is inserted in the center of the spirally wound electrode body 20. Subsequently, the spirally wound electrode body 20 is sandwiched between the pair of insulating plates 12 and 13, and is contained in the battery can 11. In this example, an end of the cathode lead 25 is attached to the safety valve mechanism 15 with the use of a welding method and/or the like, and an end of the anode lead 26 is attached to the battery can 11 with the use of a welding method and/or the like. Subsequently, an electrolytic solution obtained by dispersing an electrolyte salt in a solvent is injected into the battery can 11, and the separator 23 is impregnated with the electrolytic solution. Subsequently, at the open end of the battery can 11, the battery cover 14, the safety valve mechanism 15, and the PTC device 16 are fixed by being swaged with the gasket 17.

### [Function and Effect of Secondary Battery]

According to the cylindrical-type secondary battery, the anode active material layer 22B of the anode 22 contains the plurality of thermally-conductive particles, and the heat conductivity of the thermally-conductive particles is larger in the crossing direction DX than in the opposing direction DY. In this case, as described above, heat quantity conducted from the anode 22 to the cathode 21 is decreased by the thermal induction function of the thermally-conductive particles. Therefore, temperature of the secondary battery is less likely to be increased excessively. Therefore, even if self-heating of the secondary battery is generated, there is a low possibility of ignition and breakage. Accordingly, superior safety is obtainable.

In particular, in the case where the thermally-conductive particles have a shape in which the length is larger than the thickness, and the thermally-conductive particles are oriented so that the length direction is oriented to the crossing direction DX, higher effects are obtainable since the heat conductivity of the thermally-conductive particles is larger in the crossing direction DX than in the opposing direction DY. In this case, in the case where the thermally-conductive particles have a plate-like shape and contain boron nitride, higher effects are obtainable.

Further, in the case where the melting point of the thermally-conductive particles is higher than the melting point of the anode current collector 22A, the thermal induction function of the thermally-conductive particles is allowed to retained even if temperature of the secondary battery at the time of heat generation reaches the melting point of the anode current collector 22A.

Further, in the case where the content of the thermally-conductive particles in the anode active material layer 22B is larger on the side closer to the anode current collector 22A than on the side farther from the anode current collector 22A, higher effects are obtainable. Further, in the case where the ratio G2/G1 between the weight G1 of the anode active material and the weight G2 of the thermally-conductive particles is from 3.1 to 31 both inclusive, safety is allowed to be further improved since temperature is further less likely to be increased even if self-heating of the secondary battery is generated.

It is to be noted that instead of the active material layer (the anode active material layer 22B) of the anode 22, the active material layer (the cathode active material layer 21B) of the cathode 21 may contain the plurality of thermally-conductive particles. That is, the plurality of thermally-conductive particles may be contained in the cathode active material layer 21B located between the cathode current collector 21A and the separator 23 together with the foregoing cathode active material and the like. The configuration of the cathode active material layer 21B containing the thermally-conductive particles is similar to the foregoing configuration of the anode active material layer 22B, and cathode active material layer 21B is formed by a procedure similar to that of the anode active material layer 22B. In this case, again, heat generated in the anode 22 is less likely to be conducted to the cathode 21, in particular, the heat is less likely to be retained (concentrated) in the cathode 21, and therefore, superior safety is obtainable.

In the case where the thermally-conductive particles are contained in the cathode active material layer 21B together with the cathode active material, the average particle diameter (median diameter d50: μm) of the thermally-conductive particles is nor particularly limited. In particular, in the case where the cathode active material is an aggregation (a secondary particle) of a plurality of primary particles, the median diameter of the thermally-conductive particles may be preferably larger than the average particle diameter (median diameter d50: μm) of the primary particles of the cathode active material. One reason for this is that, in this case, even if self-heating of the secondary battery is generated, temperature is further less likely to be increased.

Further, the anode active material layer 22B may contain the plurality of thermally-conductive particles, and the cathode active material layer 21B may contain the plurality of thermally-conductive particles as well. In this case, heat generated in the anode 22 is further less likely to be conducted to the cathode 21, and therefore, temperature is further less likely to be increased even if self-heating of the secondary battery is generated. Therefore, safety is allowed to be further improved.

### [1-1-2. Location Containing Thermally-Conductive Particles: Covering Layer of Electrode]

The location containing the thermally-conductive particles may be an electrode covering layer provided on the foregoing active material layer instead of the foregoing active material layer. The configuration and the manufacturing method of the secondary battery described here are similar to the configuration and the manufacturing method of the secondary battery described in the foregoing 1-1-1., except for the points described below.

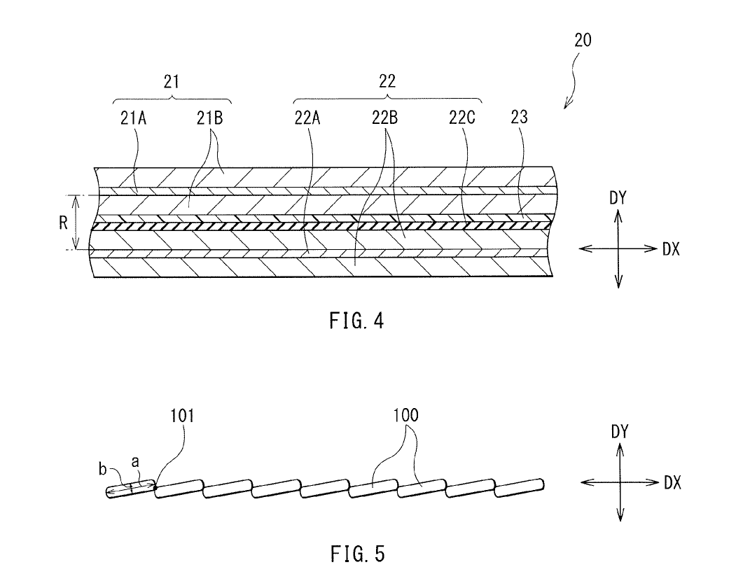

FIG. 4 illustrates another configuration of the spirally wound electrode body 20, and illustrates a cross-sectional configuration corresponding to that of FIG. 2. In this example, for example, in the anode 22, an electrode covering layer (an anode covering layer 22C) may be provided on the anode active material layer 22B. The anode covering layer 22C contains the plurality of thermally-conductive particles. That is, the plurality of thermally-conductive particles are contained in the anode covering layer 22C located between the anode active material layer 22B and the separator 23 in the region R. The function, the configuration, and the like of the thermally-conductive particles have been described above in detail, and therefore, description thereof will be omitted.

The anode covering layer 22C may be formed, for example, by one or more of a coating method, a dipping method, a vapor-phase deposition method, a liquid-phase deposition method, a spraying method, a firing method (a sintering method), and the like. In particular, the anode covering layer 22C may be preferably formed by a coating method, a dipping method, or the like, since thereby, the anode covering layer 22C may be formed easily without heating the anode active material layer 22B and the like. It is to be noted that the anode covering layer 22C may contain one or more of polymer materials as a binder together with the thermally-conductive particles. The polymer material may be, for example, polyvinylidene fluoride or the like.

FIG. 5 is a view for explaining another orientation state of the thermally-conductive particles 100, and corresponds to FIG. 3. As described above, in the case where the shape of the thermally-conductive particles 100 is a plate-like shape having the long axis a and the short axis b, part or all of the plurality of thermally-conductive particles 100 may be preferably oriented so that the length direction (the direction of the long axis a) is oriented to the crossing direction DX.

In this case, in particular, as illustrated in FIG. 5, in part or all out of the plurality of thermally-conductive particles 100, adjacent particles thereof may be preferably in contact with each other. One reason for this is that, heat is easily conducted between adjacent particles through a contact point 101, and therefore, the heat is easily induced to the crossing direction DX. In particular, adjacent particles may preferably overlap each other partly, since thereby, the area of the contact point 101 is increased, and heat is further easily conducted between the adjacent particles.

It is to be noted that, in the case where the thermally-conductive particles are contained in the anode covering layer 22C, a ratio D2/D1 between an average particle diameter D1 (median diameter d50: μm) of the anode active material and an average particle diameter D2 (median diameter d50: μm) of the thermally-conductive particles is not particularly limited. However, in particular, the ratio D2/D1 may be preferably from 0.1 to 5 both inclusive, since thereby, basic characteristics such as cycle characteristics are secured.

Upon fabricating the anode 22, a mixture of the thermally-conductive particles, a binder, and the like is dispersed in an organic solvent or the like to obtain a paste slurry. Subsequently, the anode active material layer 22B is formed on the anode current collector 22A, and thereafter, a surface of the anode active material layer 22B is coated with the slurry and the slurry is dried to form the anode covering layer 22C.

According to the cylindrical-type secondary battery, the anode covering layer 22C provided on the anode active material layer 22B of the anode 22 contains the plurality of thermally-conductive particles, and the heat conductivity of the thermally-conductive particles is larger in the crossing direction DX than in the opposing direction DY In this case, for a reason similar to that of the case in which the anode active material layer 22B contains the thermally-conductive particles, in the anode covering layer 22C, heat is induced to the crossing direction DX by the thermal induction function of the thermally-conductive particles, and therefore, temperature of the secondary battery is less likely to be increased excessively. Therefore, even if self-heating of the secondary battery is generated, there is a low possibility of ignition and breakage, and therefore, superior safety is obtainable.

In particular, in the case where the thermally-conductive particles having a shape in which the length is larger than the thickness are oriented so that the length direction is oriented to the crossing direction DX, and adjacent particles are in contact with each other partly, higher effects are obtainable. In this case, in the case where adjacent particles overlap each other partly, further higher effects are obtainable.

Other functions and other effects of the secondary battery are similar to those described in the foregoing 1-1-1.

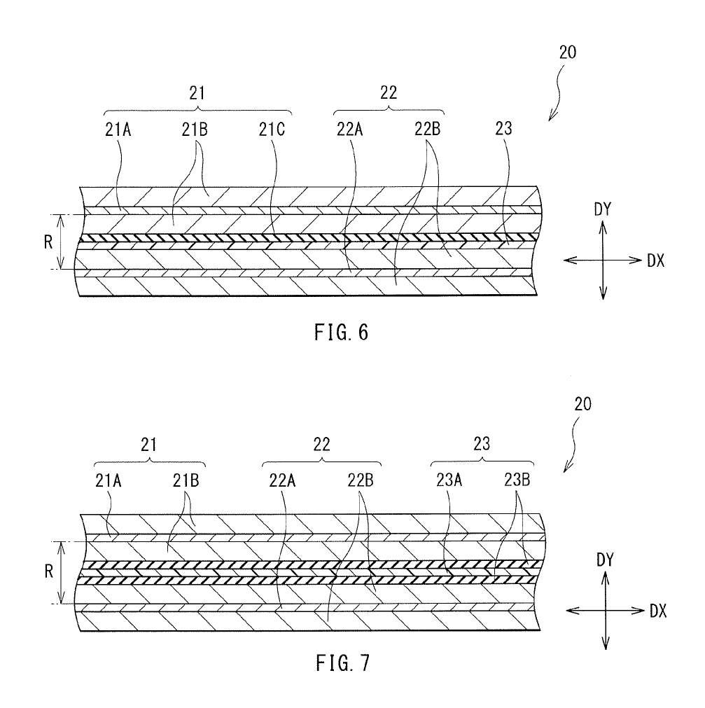

It is to be noted that, instead of the electrode covering layer (the anode covering layer 22C) provided on the anode active material layer 22B of the anode 22, as illustrated in FIG. 6 corresponding to FIG. 4, an electrode covering layer (a cathode covering layer 21C) provided on the cathode active material layer 21B of the cathode 21 may contain the thermally-conductive particles. That is, the plurality of thermally-conductive particles may be contained in the cathode covering layer 21C located between the cathode active material layer 21B and the separator 23 in the region R. The configuration of the cathode covering layer 21C containing the thermally-conductive particles is similar to the foregoing configuration of the anode covering layer 22C, and the cathode covering layer 21C is formed by a procedure similar to that of the anode covering layer 22C. In this case, again, heat generated in the anode 22 is less likely to be conducted to the cathode 21, and therefore, superior safety is obtainable.

It is to be noted that, in the case where the thermally-conductive particles are contained in the cathode covering layer 21C, a ratio M1/M2 between area density M1 (mg/cm²) of the cathode active material in the cathode active material layer 21B and area density M2 (mg/cm²) of the thermally-conductive particles in the cathode covering layer 21C is not particularly limited. In particular, the ratio M1/M2 may be preferably from 20 to 200 both inclusive, since thereby, basic characteristics such as cycle characteristics are secured.

Further, the anode covering layer 22C provided on the anode active material layer 22B may contain the plurality of thermally-conductive particles, and the cathode covering layer 21C provided on the cathode active material layer 21B may contain the plurality of thermally-conductive particles as well. In this case, heat generated in the anode 22 is less likely to be conducted to the cathode 21, and therefore, temperature is further less likely to be increased even if self-heating of the secondary battery is generated. Therefore, safety is allowed to be further improved.

### [1-1-3. Location Containing Thermally-Conductive Particles: Covering Layer of Separator]

The location containing the thermally-conductive particles may be a covering layer (a separator covering layer) of the separator 23 instead of the foregoing covering layers (the electrode covering layers) of the active material layers. The configuration and the manufacturing method of the secondary battery described here are similar to the configuration and the manufacturing method of the secondary battery described in the foregoing 1-1-1., except for the points described below.

FIG. 7 illustrates still another configuration of the spirally wound electrode body 20, and illustrates a cross-sectional configuration corresponding to those of FIG. 4 and FIG. 6. In the separator 23, for example, a separator covering layer 23B may be provided on both surfaces of a porous layer 23A. The separator covering layer 23B contains the plurality of thermally-conductive particles. That is, in the region R, the plurality of thermally-conductive particles are contained in the separator covering layer 23B located between the porous layer 23A and the cathode active material layer 21B, and are contained in the separator covering layer 23B located between the porous layer 23A and the anode active material layer 22B. The function, the configuration, and the like of the thermally-conductive particles have been described above in detail, and therefore, description thereof will be omitted. Further, the configuration of the separator covering layer 23B containing the thermally-conductive particles is similar to the foregoing configurations of the cathode covering layer 21C and the anode covering layer 22C.

In this case, again, as described referring to FIG. 3 and FIG. 5, the thermally-conductive particles 100 having a shape in which the length is larger than the thickness may be preferably oriented so that the length direction is oriented to the crossing direction DX. Further, adjacent particles may be preferably in contact with each other partly, and the adjacent particles may preferably overlap each other partly.

It is to be noted that, in the case where the separator 23 contains the plurality of thermally-conductive particles, the plurality of thermally-conductive particles should be contained not in the porous layer 23A but in the separator covering layer 23B for the following reason. First, if the porous layer 23A contains the thermally-conductive particles, fine pores in the porous layer 23A are filled with the thermally-conductive particles. Thereby, since the hole ratio of the porous layer 23A is decreased, conductivity of lithium ions through the separator 23 is decreased. In addition thereto, since a shutdown function and the like of the separator 23 are not secured, safety is lowered. Secondly, in the porous layer 23A containing the thermally-conductive particles, flexibility, tensile strength, and the like are lowered. Therefore, it is not easy to form the porous layer 23A in a state of a thin film, and it is difficult to control the orientation state of the thermally-conductive particles.

Upon fabricating the separator 23, a mixture of the thermally-conductive particles, a binder, and the like is dispersed in an organic solvent or the like to obtain paste slurry. Subsequently, both surface of the porous layer 23A are coated with the slurry, and the slurry is dried to form the separator covering layer 23B. Examples of the porous layer 23A may include a porous film made of a synthetic resin, ceramics, or the like described in 1-1-1.

According to the cylindrical-type secondary battery, the separator covering layer 23B provided on the porous layer 23A of the separator 23 contains the plurality of thermally-conductive particles, and the heat conductivity of the thermally-conductive particles is larger in the crossing direction DX than in the opposing direction DY In this case, for a reason similar to that of the case in which the anode active material layer 22B contains the thermally-conductive particles, in the separator covering layer 23B, heat is induced to the crossing direction DX by the thermal induction function of the thermally-conductive particles, and therefore, the thermal quantity conducted from the anode 22 to the cathode 21 is decreased. Even if self-heating of the secondary battery is generated, there is a low possibility of ignition and breakage, and therefore, superior safety is obtainable. Other functions and other effects of the secondary battery are similar to those described in the foregoing 1-1-1.

Although not illustrated specifically, in the separator 23, the separator covering layer 23B may be provided only on a single surface of the porous layer 23A. The surface of the porous layer 23A on which the separator covering layer 23B is provided may be the surface on the side opposed to the cathode 21, or the surface on the side opposed to the anode 22. One reason for this is that, since the separator 23 is located between the cathode 21 and the anode 22, heat generated in the anode 22 is less likely to be conducted to the cathode 21 even if the separator covering layer 23B is provided only on a single surface of the porous layer 23A.

### [1-1-4 Summary of Location Containing Thermally-Conductive Particles]

In the foregoing 1-1-1. to 1-1-3., the description has been separately given of the case in which the location containing the thermally-conductive particles is any of the active material layers, the case in which the location containing the thermally-conductive particles is any of the covering layers of the electrodes, and the case in which the location containing the thermally-conductive particles is the covering layer of the separator. However, for the locations containing the thermally-conductive particles, two or more of the foregoing locations may be combined as an arbitrary combination.

As an example, in the anode 22, the anode active material layer 22B may contain the thermally-conductive particles, and the anode covering layer 22C may contain the thermally-conductive particles as well. Further, all of the cathode active material layer 21B, the cathode covering layer 21C, the anode active material layer 22B, the anode covering layer 22C, and the separator covering layer 23B may contain the plurality of thermally-conductive particles.

In any combination, the thermal induction function of the thermally-conductive particles is exercised, and therefore, superior safety is obtainable.

### [1-2. Lithium Ion Secondary Battery (Laminated-Film-Type)]

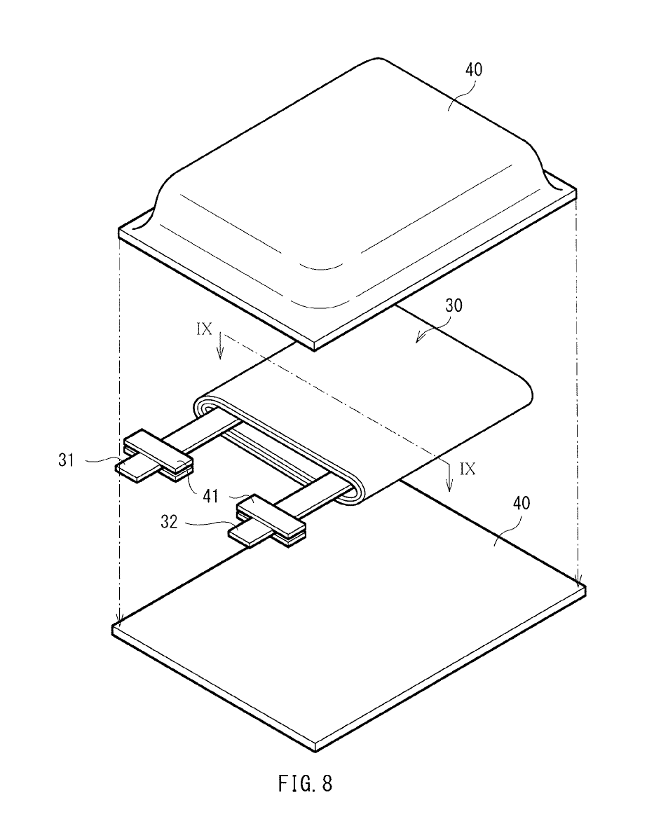

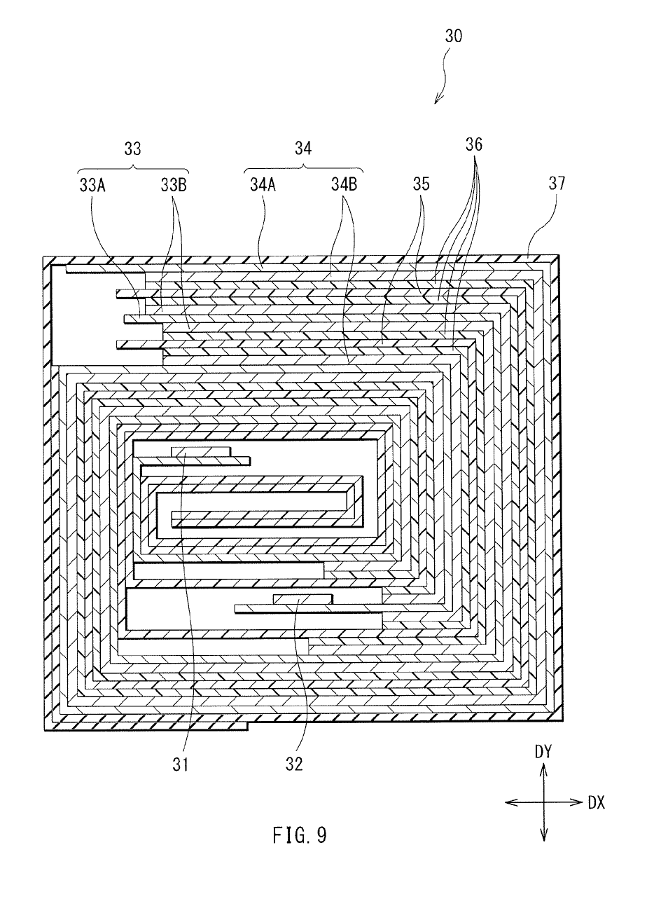

FIG. 8 illustrates an exploded perspective configuration of another secondary battery in the embodiment of the present technology. FIG. 9 illustrates an enlarged cross-section taken along a line IX-IX of a spirally wound electrode body 30 illustrated in FIG. 8. In the following description, the elements of the cylindrical-type secondary battery described above will be used as necessary.

### [Whole Configuration of Secondary Battery]

The secondary battery described here may be, for example, a so-called laminated-film-type lithium ion secondary battery. For example, in the secondary battery, the spirally wound electrode body 30 may be contained in a film-like outer package member 40. The spirally wound electrode body 30 is formed by laminating a cathode 33 and an anode 34 with a separator 35 and an electrolyte layer 36 in between, and subsequently spirally winding the resultant laminated body. The cathode 33 and the anode 34 are opposed to each other with the separator 35 in between. A cathode lead 31 is attached to the cathode 33, and an anode lead 32 is attached to the anode 34. The outermost periphery of the spirally wound electrode body 30 is protected by a protective tape 37.

The cathode lead 31 and the anode lead 32 may be, for example, led out from inside to outside of the outer package member 40 in the same direction. The cathode lead 31 may be made, for example, of an electrically-conductive material such as aluminum, and the anode lead 32 may be made, for example, of an electrically-conducive material such as copper, nickel, and stainless steel. These electrically-conductive materials may be in the shape of, for example, a thin plate or mesh.

The outer package member 40 may be a laminated film in which, for example, a fusion bonding layer, a metal layer, and a surface protective layer are laminated in this order. In the laminated film, for example, outer edges of two film fusion bonding layers may be fusion-bonded so that the fusion bonding layers and the spirally wound electrode body 30 are opposed to each other. Alternatively, the two films may be attached to each other by an adhesive or the like. Examples of the fusion bonding layer may include a film made of polyethylene, polypropylene, or the like. Examples of the metal layer may include an aluminum foil. Examples of the surface protective layer may include a film made of nylon, polyethylene terephthalate, or the like.

In particular, as the outer package member 40, an aluminum laminated film in which a polyethylene film, an aluminum foil, and a nylon film are laminated in this order may be preferable. However, the outer package member 40 may be made of a laminated film having other laminated structure, a polymer film such as polypropylene, or a metal film.

An adhesive film 41 to protect from outside air intrusion is inserted between the outer package member 40 and the cathode lead 31 and between the outer package member 40 and the anode lead 32. The adhesive film 41 is made of a material having adhesibility with respect to the cathode lead 31 and the anode lead 32. Examples of the material having adhesibility may include one or more of polyolefin resins such as polyethylene, polypropylene, modified polyethylene, and modified polypropylene.

The cathode 33 may have, for example, a cathode active material layer 33B on a single surface or both surfaces of a cathode current collector 33A. The anode 34 may have, for example, an anode active material layer 34B on a single surface or both surfaces of an anode current collector 34A. The configurations of the cathode current collector 33A, the cathode active material layer 33B, the anode current collector 34A, and the anode active material layer 34B are similar to the configurations of the cathode current collector 21A, the cathode active material layer 21B, the anode current collector 22A, and the anode active material layer 22B, respectively. The configuration of the separator 35 is similar to the configuration of the separator 23. That is, one or more of the cathode 33, the anode 34, and the separator 35 contain the plurality of thermally-conductive particles. Heat conductivity of the thermally-conductive particles is larger in the direction (the crossing direction DX) that intersects with the direction (the opposing direction DY) in which the cathode 33 and the anode 34 are opposed to each other than in the opposing direction DY.

In the electrolyte layer 36, an electrolytic solution is supported by a polymer compound. The electrolyte layer 36 is a so-called gel electrolyte, since thereby, high ion conductivity (for example, 1 mS/cm or more at room temperature) is obtained and liquid leakage of the electrolytic solution is prevented. The electrolyte layer 36 may contain other material such as an additive as necessary.

The polymer compound may be, for example, one or more of polyacrylonitrile, polyvinylidene fluoride, polytetrafluoroethylene, polyhexafluoropropylene, polyethylene oxide, polypropylene oxide, polyphosphazene, polysiloxane, polyvinyl fluoride, polyvinyl acetate, polyvinyl alcohol, polymethacrylic acid methyl, polyacrylic acid, polymethacrylic acid, styrene-butadiene rubber, nitrile-butadiene rubber, polystyrene, and polycarbonate. In addition thereto, examples of the polymer compounds may include a copolymer of vinylidene fluoride and hexafluoro propylene. In particular, polyvinylidene fluoride and the foregoing copolymer may be preferable, and polyvinylidene fluoride may be more preferable, since such a polymer compound is electrochemically stable.

The composition of the electrolytic solution is similar to the composition of the electrolytic solution of the cylindrical-type secondary battery. However, in the electrolyte layer 36 as a gel electrolyte, the term “solvent” of the electrolytic solution refers to a wide concept including not only a liquid solvent but also a material having ion conductivity capable of dissociating the electrolyte salt. Therefore, in the case where a polymer compound having ion conductivity is used, the polymer compound is also included in the solvent.

It is to be noted that the electrolytic solution may be used as it is instead of the gel electrolyte layer 36. In this case, the separator 35 is impregnated with the electrolytic solution.

### [Operation of Secondary Battery]

In the secondary battery, for example, lithium ions extracted from the cathode 33 may be inserted in the anode 34 through the electrolyte layer 36 at the time of charge, and lithium ions extracted from the anode 34 may be inserted in the cathode 33 through the electrolyte layer 36 at the time of discharge.

### [Method of Manufacturing Secondary Battery]

The secondary battery including the gel electrolyte layer 36 may be manufactured, for example, by the following three types of procedures.

In the first procedure, the cathode 33 and the anode 34 are fabricated by a fabrication procedure similar to that of the cathode 21 and the anode 22. In this case, the cathode active material layer 33B is formed on a single surface or both surfaces of the cathode current collector 33A to form the cathode 33, and the anode active material layer 34B is formed on a single surface or both surfaces of the anode current collector 34A to form the anode 34. Subsequently, a precursor solution including an electrolytic solution, a polymer compound, and a solvent such as an organic solvent is prepared. Thereafter, the cathode 33 and the anode 34 are coated with the precursor solution to form the gel electrolyte layer 36. Subsequently, the cathode lead 31 is attached to the cathode current collector 33A with the use of a welding method and/or the like, and the anode lead 32 is attached to the anode current collector 34A with the use of a welding method and/or the like similarly. Subsequently, the cathode 33 and the anode 34 are layered with the separator 35 in between and are spirally wound to fabricate the spirally wound electrode body 30. Thereafter, the protective tape 37 is adhered to the outermost periphery thereof. Subsequently, after the spirally wound electrode body 30 is sandwiched between two pieces of film-like outer package members 40, the outer edges of the outer package members 40 are bonded with the use of a thermal fusion bonding method and/or the like. Thereby, the spirally wound electrode body 30 is enclosed into the outer package members 40. In this case, the adhesive films 41 are inserted between the cathode lead 31 and the outer package member 40 and between the anode lead 32 and the outer package member 40.

In the second procedure, the cathode lead 31 is attached to the cathode 33, and the anode lead 32 is attached to the anode 34. Subsequently, the cathode 33 and the anode 34 are layered with the separator 35 in between and are spirally wound to fabricate a spirally wound body as a precursor of the spirally wound electrode body 30. Thereafter, the protective tape 37 is adhered to the outermost periphery thereof. Subsequently, after the spirally wound body is sandwiched between two pieces of the film-like outer package members 40, the outermost peripheries except for one side are bonded with the use of a thermal fusion bonding method and/or the like to obtain a pouched state, and the spirally wound body is contained in the pouch-like outer package member 40. Subsequently, a composition for electrolyte containing an electrolytic solution, a monomer as a raw material for the polymer compound, a polymerization initiator, and other materials such as a polymerization inhibitor as necessary is prepared, and the composition for electrolyte is injected into the pouch-like outer package member 40. Thereafter, the outer package member 40 is hermetically sealed with the use of a thermal fusion bonding method and/or the like. Subsequently, the monomer is thermally polymerized, and thereby, a polymer compound is formed. Accordingly, the electrolyte layer 36 is formed.

In the third procedure, the spirally wound body is fabricated and contained in the pouch-like outer package member 40 in a manner similar to that of the foregoing second procedure, except that the separator 35 with both surfaces coated with a polymer compound is used. Examples of the polymer compound with which the separator 35 is coated may include a polymer (a homopolymer, a copolymer, or a multicomponent copolymer) containing vinylidene fluoride as a component. Specific examples thereof may include polyvinylidene fluoride, a binary copolymer containing vinylidene fluoride and hexafluoro propylene as components, and a ternary copolymer containing vinylidene fluoride, hexafluoro propylene, and chlorotrifluoroethylene as components. It is to be noted that, in addition to the polymer containing vinylidene fluoride as a component, other one or more polymer compounds may be used. Subsequently, an electrolytic solution is prepared and injected into the outer package member 40. Thereafter, the opening of the outer package member 40 is hermetically sealed with the use of a thermal fusion bonding method and/or the like. Subsequently, the resultant is heated while a weight is applied to the outer package member 40, and the separator 35 is adhered to the cathode 33 and the anode 34 with the polymer compound in between. Thereby, the polymer compound is impregnated with the electrolytic solution, and accordingly, the polymer compound is gelated to form the electrolyte layer 36.

In the third procedure, swollenness of the secondary battery is suppressed more than in the first procedure. Further, in the third procedure, the monomer as a raw material of the polymer compound, the solvent, and the like are less likely to be left in the electrolyte layer 36 compared to in the second procedure. Therefore, the formation step of the polymer compound is favorably controlled. Therefore, the cathode 33, the anode 34, and the separator 35 sufficiently adhere to the electrolyte layer 36.

### [Function and Effect of Secondary Battery]

According to the laminated-film-type secondary battery, one or more of the cathode 33, the anode 34, and the separator 35 contain the plurality of thermally-conductive particles. Therefore, for a reason similar to that of the cylindrical-type secondary battery described above, superior safety is obtainable. Other functions, other effects, and other modifications are similar to those of the cylindrical-type secondary battery.

### [1-3. Lithium Metal Secondary Battery (Cylindrical-Type and Laminated-Film-Type)]

A secondary battery described here is a lithium secondary battery (a lithium metal secondary battery) in which the capacity of the anode 22 is represented by precipitation and dissolution of lithium metal. The secondary battery has a configuration similar to that of the foregoing lithium ion secondary battery (the cylindrical-type lithium ion secondary battery), except that the anode active material layer 22B is configured of the lithium metal, and is manufactured by a procedure similar to that of the lithium ion secondary battery (the cylindrical-type lithium ion secondary battery).

In the secondary battery, the lithium metal is used as an anode active material, and thereby, higher energy density is obtainable. The anode active material layer 22B may exist at the time of assembling, or the anode active material layer 22B does not necessarily exist at the time of assembling and may be configured of the lithium metal precipitated at the time of charge. Further, the anode active material layer 22B may be used as a current collector, and thereby, the anode current collector 22A may be omitted.

In the secondary battery, for example, at the time of charge, lithium ions discharged from the cathode 21 may be precipitated as the lithium metal on the surface of the anode current collector 22A through the electrolytic solution. In contrast, for example, at the time of discharge, the lithium metal may be eluded as lithium ions from the anode active material layer 22B, and may be inserted in the cathode 21 through the electrolytic solution.

According to the lithium metal secondary battery, one or more of the cathode 21, the anode 22, and the separator 23 contain the plurality of thermally-conductive particles. Therefore, for a reason similar to that of the lithium ion secondary battery described above, superior safety is obtainable. Other functions, other effects, and other modifications are similar to those of the cylindrical-type secondary battery. It is to be noted that the foregoing lithium metal secondary battery is not limited to the cylindrical-type secondary battery, and may be a laminated-film-type secondary battery. In that case, a similar effect is obtainable as well.

### [2. Applications of Secondary Battery]

Next, description will be given of application examples of the foregoing secondary battery.

Applications of the secondary battery are not particularly limited as long as the secondary battery is applied to a machine, a device, an instrument, an apparatus, a system (a collective entity of a plurality of devices and the like), or the like that is allowed to use the secondary battery as a driving electric power source, an electric power storage source for electric power storage, or the like. The secondary battery used as an electric power source may be a main electric power source (electric power source used preferentially), or may be an auxiliary electric power source (electric power source used instead of a main electric power source or used being switched from the main electric power source). In the case where the secondary battery is used as an auxiliary electric power source, the main electric power source type is not limited to the secondary battery.

Examples of applications of the secondary battery may include electronic apparatuses (including portable electronic apparatuses) such as a video camcorder, a digital still camera, a mobile phone, a notebook personal computer, a cordless phone, a headphone stereo, a portable radio, a portable television, and a personal digital assistant. Further examples thereof may include a mobile lifestyle electric appliance such as an electric shaver; a memory device such as a backup electric power source and a memory card; an electric power tool such as an electric drill and an electric saw; a battery pack used for a notebook personal computer or the like as an attachable and detachable electric power source; a medical electronic apparatus such as a pacemaker and a hearing aid; an electric vehicle such as an electric automobile (including a hybrid automobile); and an electric power storage system such as a home battery system for storing electric power for emergency or the like. It goes without saying that an application other than the foregoing applications may be adopted.

In particular, the secondary battery is effectively applicable to the battery pack, the electric vehicle, the electric power storage system, the electric power tool, the electronic apparatus, or the like. One reason for this is that, in these applications, since superior battery characteristics are demanded, performance is effectively improved with the use of the secondary battery according to the embodiment of the present technology. It is to be noted that the battery pack is an electric power source using a secondary battery, and is a so-called assembled battery or the like. The electric vehicle is a vehicle that works (runs) with the use of a secondary battery as a driving electric power source. As described above, the electric vehicle may be an automobile (such as a hybrid automobile) including a drive source other than a secondary battery. The electric power storage system is a system using a secondary battery as an electric power storage source. For example, in a home electric power storage system, since electric power is stored in the secondary battery as an electric power storage source, the electric power is utilized, and thereby, home electric products and the like become usable. The electric power tool is a tool in which a movable section (such as a drill) is moved with the use of a secondary battery as a driving electric power source. The electronic apparatus is an apparatus executing various functions with the use of a secondary battery as a driving electric power source (electric power supply source).

Description will be specifically given of some application examples of the secondary battery. It is to be noted that the configurations of the respective application examples explained below are merely examples, and may be changed as appropriate.

### [2-1. Battery Pack]

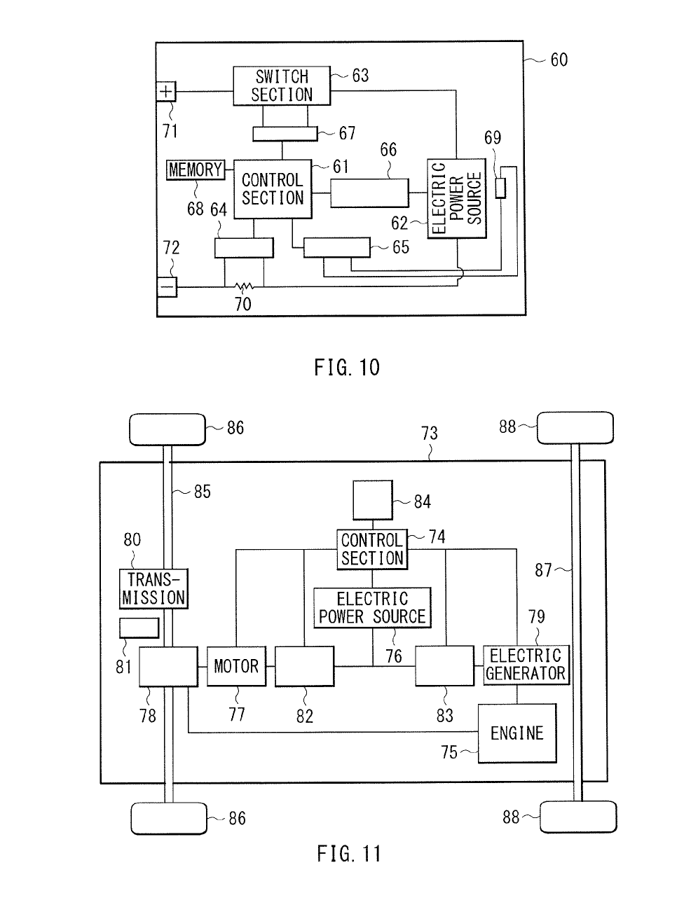

FIG. 10 illustrates a block configuration of a battery pack. For example, the battery pack may include a control section 61, an electric power source 62, a switch section 63, a current measurement section 64, a temperature detection section 65, a voltage detection section 66, a switch control section 67, a memory 68, a temperature detection device 69, a current detection resistance 70, a cathode terminal 71, and an anode terminal 72 in a housing 60 made of a plastic material and/or the like.

The control section 61 controls operation of the whole battery pack (including operation of the electric power source 62), and may include, for example, a central processing unit (CPU) and/or the like. The electric power source 62 includes one or more secondary batteries (not illustrated). The electric power source 62 may be, for example, an assembled battery including two or more secondary batteries. Connection type of these secondary batteries may be a series-connected type, may be a parallel-connected type, or a mixed type thereof. As an example, the electric power source 62 may include six secondary batteries connected in a manner of dual-parallel and three-series.

The switch section 63 switches the operation of the electric power source 62 (whether or not the electric power source 62 is connectable to an external device) according to an instruction of the control section 61. The switch section 63 may include, for example, a charge control switch, a discharge control switch, a charging diode, a discharging diode, and the like (not illustrated). The charge control switch and the discharge control switch may each be, for example, a semiconductor switch such as a field-effect transistor (MOSFET) using a metal oxide semiconductor.

The current measurement section 64 measures a current with the use of the current detection resistance 70, and outputs the measurement result to the control section 61. The temperature detection section 65 measures temperature with the use of the temperature detection device 69, and outputs the measurement result to the control section 61. The temperature measurement result may be used for, for example, a case in which the control section 61 controls charge and discharge at the time of abnormal heat generation or a case in which the control section 61 performs a correction processing at the time of calculating a remaining capacity. The voltage detection section 66 measures a voltage of the secondary battery in the electric power source 62, performs analog-to-digital conversion on the measured voltage, and supplies the resultant to the control section 61.

The switch control section 67 controls operations of the switch section 63 according to signals inputted from the current measurement section 64 and the voltage detection section 66.

The switch control section 67 executes control so that a charging current is prevented from flowing in a current path of the electric power source 62 by disconnecting the switch section 63 (charge control switch) in the case where, for example, a battery voltage reaches an overcharge detection voltage. Thereby, in the electric power source 62, only discharge is allowed to be performed through the discharging diode. It is to be noted that, for example, in the case where a large current flows at the time of charge, the switch control section 67 blocks the charging current.

Further, the switch control section 67 executes control so that a discharging current is prevented from flowing in the current path of the electric power source 62 by disconnecting the switch section 63 (discharge control switch) in the case where, for example, a battery voltage reaches an overdischarge detection voltage. Thereby, in the electric power source 62, only charge is allowed to be performed through the charging diode. It is to be noted that, for example, in the case where a large current flows at the time of discharge, the switch control section 67 blocks the discharging current.

It is to be noted that, in the secondary battery, for example, the overcharge detection voltage may be 4.2 V±0.05 V, and the over-discharge detection voltage may be 2.4 V±0.1 V.

The memory 68 may be, for example, an EEPROM as a non-volatile memory or the like. The memory 68 may store, for example, numerical values calculated by the control section 61, information of the secondary battery measured in a manufacturing step (such as an internal resistance in the initial state), and the like. It is to be noted that, in the case where the memory 68 stores a full charge capacity of the secondary battery, the control section 61 is allowed to comprehend information such as a remaining capacity.

The temperature detection device 69 measures temperature of the electric power source 62, and outputs the measurement result to the control section 61. The temperature detection device 69 may be, for example, a thermistor or the like.

The cathode terminal 71 and the anode terminal 72 are terminals connected to an external device (such as a notebook personal computer) driven using the battery pack or an external device (such as a battery charger) used for charging the battery pack. The electric power source 62 is charged and discharged through the cathode terminal 71 and the anode terminal 72.

### [2-2. Electric Vehicle]

FIG. 11 illustrates a block configuration of a hybrid automobile as an example of electric vehicles. For example, the electric vehicle may include a control section 74, an engine 75, an electric power source 76, a driving motor 77, a differential 78, an electric generator 79, a transmission 80, a clutch 81, inverters 82 and 83, and various sensors 84 in a housing 73 made of metal. In addition thereto, the electric vehicle may include, for example, a front drive shaft 85 and a front tire 86 that are connected to the differential 78 and the transmission 80, a rear drive shaft 87, and a rear tire 88.

The electric vehicle may run with the use, for example, of one of the engine 75 and the motor 77 as a drive source. The engine 75 is a main power source, and may be, for example, a petrol engine. In the case where the engine 75 is used as a power source, drive power (torque) of the engine 75 may be transferred to the front tire 86 or the rear tire 88 through the differential 78, the transmission 80, and the clutch 81 as drive sections, for example. The torque of the engine 75 may also be transferred to the electric generator 79. Due to the torque, the electric generator 79 generates alternating-current electric power. The alternating-current electric power is converted into direct-current electric power through the inverter 83, and the converted power is stored in the electric power source 76. In contrast, in the case where the motor 77 as a conversion section is used as a power source, electric power (direct-current electric power) supplied from the electric power source 76 is converted into alternating-current electric power through the inverter 82. The motor 77 may be driven by the alternating-current electric power. Drive power (torque) obtained by converting the electric power by the motor 77 may be transferred to the front tire 86 or the rear tire 88 through the differential 78, the transmission 80, and the clutch 81 as the drive sections, for example.

It is to be noted that, alternatively, the following mechanism may be adopted. In the mechanism, when speed of the electric vehicle is reduced by an unillustrated brake mechanism, the resistance at the time of speed reduction is transferred to the motor 77 as torque, and the motor 77 generates alternating-current electric power by the torque. It may be preferable that the alternating-current electric power be converted to direct-current electric power through the inverter 82, and the direct-current regenerative electric power be stored in the electric power source 76.

The control section 74 controls operations of the whole electric vehicle, and, for example, may include a CPU and/or the like. The electric power source 76 includes one or more secondary batteries (not illustrated). Alternatively, the electric power source 76 may be connected to an external electric power source, and electric power may be stored by receiving the electric power from the external electric power source. The various sensors 84 may be used, for example, for controlling the number of revolutions of the engine 75 or for controlling opening level (throttle opening level) of an unillustrated throttle valve. The various sensors 84 may include, for example, a speed sensor, an acceleration sensor, an engine frequency sensor, and/or the like.

The description has been given above of the hybrid automobile as an electric vehicle. However, examples of the electric vehicles may include a vehicle (electric automobile) working with the use of only the electric power source 76 and the motor 77 without using the engine 75.

### [2-3. Electric Power Storage System]

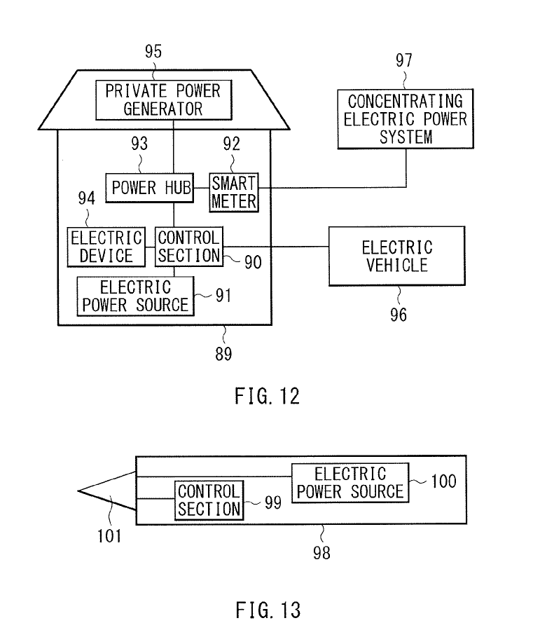

FIG. 12 illustrates a block configuration of an electric power storage system. For example, the electric power storage system may include a control section 90, an electric power source 91, a smart meter 92, and a power hub 93 inside a house 89 such as a general residence and a commercial building.

In this case, the electric power source 91 may be connected to, for example, an electric device 94 arranged inside the house 89, and may be connected to an electric vehicle 96 parked outside the house 89. Further, for example, the electric power source 91 may be connected to a private power generator 95 arranged inside the house 89 through the power hub 93, and may be connected to an external concentrating electric power system 97 thorough the smart meter 92 and the power hub 93.

It is to be noted that the electric device 94 may include, for example, one or more home electric appliances such as a refrigerator, an air conditioner, a television, and a water heater. The private power generator 95 may be, for example, one or more of a solar power generator, a wind-power generator, and the like. The electric vehicle 96 may be, for example, one or more of an electric automobile, an electric motorcycle, a hybrid automobile, and the like. The concentrating electric power system 97 may be, for example, one or more of a thermal power plant, an atomic power plant, a hydraulic power plant, a wind-power plant, and the like.

The control section 90 controls operation of the whole electric power storage system (including operation of the electric power source 91), and, for example, may include a CPU and/or the like. The electric power source 91 includes one or more secondary batteries (not illustrated). The smart meter 92 may be, for example, an electric power meter compatible with a network arranged in the house 89 demanding electric power, and may be communicable with an electric power supplier. Accordingly, for example, while the smart meter 92 communicates with outside, the smart meter 92 controls the balance between supply and demand in the house 89 and allows effective and stable energy supply.

In the electric power storage system, for example, electric power may be stored in the electric power source 91 from the concentrating electric power system 97 as an external electric power source through the smart meter 92 and the power hub 93, and electric power may be stored in the electric power source 91 from the private power generator 95 as an independent electric power source through the power hub 93. The electric power stored in the electric power source 91 is supplied to the electric device 94 or to the electric vehicle 96 according to an instruction of the control section 90. Therefore, the electric device 94 becomes operable, and the electric vehicle 96 becomes chargeable. That is, the electric power storage system is a system capable of storing and supplying electric power in the house 89 with the use of the electric power source 91.

The electric power stored in the electric power source 91 is arbitrarily usable. Therefore, for example, electric power is allowed to be stored in the electric power source 91 from the concentrating electric power system 97 in the middle of the night when an electric rate is inexpensive, and the electric power stored in the electric power source 91 is allowed to be used during daytime hours when an electric rate is expensive.

It is to be noted that the foregoing electric power storage system may be arranged for each household (family unit), or may be arranged for a plurality of households (family units).

### [2-4. Electric Power Tool]

FIG. 13 illustrates a block configuration of an electric power tool. For example, the electric power tool may be an electric drill, and may include a control section 99 and an electric power source 100 in a tool body 98 made of a plastic material and/or the like. For example, a drill section 101 as a movable section may be attached to the tool body 98 in an operable (rotatable) manner.

The control section 99 controls operations of the whole electric power tool (including operation of the electric power source 100), and may include, for example, a CPU and/or the like. The electric power source 100 includes one or more secondary batteries (not illustrated). The control section 99 allows electric power to be supplied from the electric power source 100 to the drill section 101 according to operation of an unillustrated operation switch to operate the drill section 101.

### EXAMPLES

Specific Examples according to the embodiment of the present technology will be described in detail.

### Examples 1-1 to 1-36

The cylindrical-type lithium ion secondary battery illustrated in FIG. 1 and FIG. 2 was fabricated by the following procedure.

Upon fabricating the cathode 21, first, 96 parts by mass of a cathode active material (LiNiO₂), 3 parts by mass of a cathode binder (polyvinylidene fluoride), and 1 part by mass of a cathode electric conductor (carbon black) were mixed to obtain a cathode mixture. Particle diameters (median diameters d50: μm) of primary particles of the cathode active material were as illustrated in Table 1 to Table 3. Subsequently, the cathode mixture was dispersed in an organic solvent (N-methyl-2-pyrrolidone) to obtain paste cathode mixture slurry. When thermally-conductive particles were contained in the cathode active material layer 21B, the thermally-conductive particles were added to the cathode mixture slurry. Types (materials), particle diameters (median diameters d50: μm), ratios G2/G1, shapes, and distributions in the layer of the thermally-conductive particles were as illustrated in Table 1 to Table 3. Subsequently, both surfaces of the strip-shaped cathode current collector 21A (an aluminum foil being 15 μm thick) were uniformly coated with the cathode mixture slurry with the use of a coating equipment, and the cathode mixture slurry was dried to form the cathode active material layer 21B. In the tables, “Uniform” of a distribution in the layer refers to a state that the thermally-conductive particles were substantially uniformly dispersed in the thickness direction of the cathode active material layer 21B. Finally, the cathode active material layer 21B was compression-molded with the use of a roll pressing machine.

Upon fabricating the anode 22, first, 65 parts by mass of an anode active material (Si), 15 parts by mass of an anode binder (polyvinylidene fluoride), and 20 parts by mass of an anode electric conductor (carbon black) were mixed to obtain an anode mixture. Particle diameters (median diameters d50: μm) of the anode active material were as illustrated in Table 1 to Table 3. Subsequently, the anode mixture was dispersed in an organic solvent (N-methyl-2-pyrrolidone) to obtain paste anode mixture slurry. When the thermally-conductive particles were contained in the anode active material layer 22B, the thermally-conductive particles were added to the anode mixture slurry as in the case where the thermally-conductive particles were contained in the cathode active material layer 21B. Subsequently, both surfaces of the anode current collector 22A (a copper foil being 15 μm thick) were uniformly coated with the anode mixture slurry with the use of a coating equipment, and the anode mixture slurry was dried to form the anode active material layer 22B. Distributions in the layer of the thermally-conductive particles in the anode active material layer 22B were as illustrated in Table 1 to Table 3. Finally, the anode active material layer 22B was compression-molded with the use of a roll pressing machine.

Upon forming the anode active material layer 22B, in order to change the distribution in the layer of the thermally-conductive particles, the anode active material layer 22B was formed to have a two-layer structure including the lower layer and the upper layer. In this case, after two types of anode mixture slurry having different contents of the thermally-conductive particles were prepared, such two types of anode mixture slurry were sequentially used to form the lower layer and the upper layer. The distributions of the thermally-conductive particles in the anode active material layer 22B were as illustrated in Table 1 to Table 3. In the tables, “High content on current collector side” of a distribution in the layer refers to a state that the content of the thermally-conductive particles in the anode active material layer 22B was higher on the side closer to the anode current collector 22A than on the side farther from the anode current collector 22A. In this case, after the lower layer was formed with the use of a first slurry having a relatively higher content of the thermally-conductive particles, the upper layer was formed with the use of a second slurry having a relatively smaller content of the thermally-conductive particles. In contrast, in the tables, “Small content on current collector side” of a distribution in the layer refers to a state that the content of the thermally-conductive particles in the anode active material layer 22B was smaller on the side closer to the anode current collector 22A than on the side farther from the anode current collector 22A. In this case, after the lower layer was formed with the use of a first slurry having a relatively smaller content of the thermally-conductive particles, the upper layer was formed with the use of a second slurry having a relatively higher content of the thermally-conductive particles.

Upon preparing an electrolytic solution, an electrolyte salt (LiPF₆) was dissolved in a solvent (ethylene carbonate, diethyl carbonate, and vinylene carbonate). In these examples, the solvent composition at a weight ratio was ethylene carbonate:diethyl carbonate:vinylene carbonate=30:60:10, and the content of the electrolyte salt with respect to the solvent was 1 mol/dm³ (=1 mol/l).

Upon assembling the secondary battery, first, the cathode lead 25 made of aluminum was welded to the cathode current collector 21A, and the anode lead 26 made of nickel was welded to the anode current collector 22A. Subsequently, the cathode 21 and the anode 22 were layered with the separator 23 in between and were spirally wound. Thereafter, the spirally-wound end portion of the resultant spirally wound body was fixed with the use of an adhesive tape to fabricate the spirally wound electrode body 20. As the separator 23, a three-layer film (the total thickness of 25 μm) in which a porous polyethylene film was sandwiched between porous polypropylene films was used. Subsequently, the center pin 24 was inserted in the hollow space of the center of the spirally wound electrode body 20. Subsequently, the spirally wound electrode body 20 was sandwiched between the pair of insulating plates 12 and 13, and was contained in the battery can 11 made of iron plated with nickel. In these examples, an end of the cathode lead 25 was welded to the safety valve mechanism 15, and an end of the anode lead 26 was welded to the battery can 11. Subsequently, an electrolytic solution was injected into the battery can 11 by a depressurization method, and the separator 23 was impregnated with the electrolytic solution. Finally, at the open end of the battery can 11, the battery cover 14, the safety valve mechanism 15, and the PTC device 16 were fixed by being swaged with the gasket 17. Thereby, the cylindrical-type secondary battery was completed. It is to be noted that when the secondary battery was fabricated, lithium metal was prevented from being precipitated on the anode 22 at the time of full charge by adjusting the thickness of the cathode active material layer 21B.

Safety characteristics of the secondary battery were examined, and results illustrated in Table 1 to Table 3 were obtained. Upon examining the safety, charge was performed until the battery voltage reached 4.2 V, and thereafter, the secondary battery in the charged state was kept in the high temperature environment (135 deg C) for one hour, and the battery state was examined. In these examples, the maximum value (the maximum temperature: deg C) of temperature on a side surface of the battery can 11 was measured with the use of a thermocouple. Further, evaluation was made as “good” in the case where ignition, bursting, and/or the like did not occur, and evaluation was made as “poor” in the case where ignition, bursting, and/or the like occurred.

TABLE 1
Location containing thermally-conductive particles: cathode (cathode
active material layer) or anode (anode active material layer)

| | Cathode active material | | Anode active material | | | |
|---|---|---|---|---|---|---|
| | | Particle | | Particle | Thermally-conductive particles | |
| | | diameter | | diameter | Containing | |
| Example | Type | (μm) | Type | (μm) | location | Type |
| 1-1 | LiNiO₂ | 5 | Si | 10 | Anode | BN |
| | | | | | active | |
| | | | | | material | |
| | | | | | layer | |
| 1-2 | | | | | | |
| 1-3 | | | | | | |
| 1-4 | | | | | | |
| 1-5 | | | | | | |
| 1-6 | | | | | | |
| 1-7 | | | | | | |
| 1-8 | | | | 5 | | |
| 1-9 | | | | | | |
| 1-10 | | | | | | |
| 1-11 | | | | 10 | | |
| 1-12 | | | | | | |
| 1-13 | | | | | | |
| 1-14 | | | | 20 | | |
| 1-15 | | | | | | |
| 1-16 | | | | | | |

| | Thermally-conductive particles | | | | | |
|---|---|---|---|---|---|---|
| | Particle | | | | Maximum | |
| | diameter | G2/ | | Distribution | temperature | |
| Example | (μm) | G1 | Shape | in layer | (deg C.) | Evaluation |
| 1-1 | 5 | 1.5 | Scale-like | Uniform | 205 | good |
| 1-2 | | 2.8 | | | 203 | good |
| 1-3 | | 3.1 | | | 189 | good |
| 1-4 | | 10 | | | 160 | good |
| 1-5 | | 18 | | | 162 | good |
| 1-6 | | 29 | | | 150 | good |
| 1-7 | | 31 | | | 150 | good |
| 1-8 | 0.4 | 10 | | | 201 | good |
| 1-9 | 0.6 | | | | 180 | good |
| 1-10 | 2.5 | | | | 172 | good |
| 1-11 | 0.9 | | | | 197 | good |
| 1-12 | 1.1 | | | | 183 | good |
| 1-13 | 1.8 | | | | 166 | good |
| 1-14 | 1.9 | | | | 191 | good |
| 1-15 | 2.1 | | | | 155 | good |
| 1-16 | 5.8 | | | | 149 | good |

TABLE 2
Location containing thermally-conductive particles: cathode (cathode
active material layer) or anode (anode active material layer)

| | Cathode active material | | Anode active material | | | |
|---|---|---|---|---|---|---|
| | | Particle | | Particle | Thermally-conductive particles | |
| | | diameter | | diameter | Containing | |
| Example | Type | (μm) | Type | (μm) | location | Type |
| 1-17 | LiNiO₂ | 3 | Si | 10 | Cathode | BN |
| | | | | | active | |
| | | | | | material | |
| | | | | | layer | |
| 1-18 | | | | | | |
| 1-19 | | | | | | |
| 1-20 | | 5 | | | | |
| 1-21 | | | | | | |
| 1-22 | | | | | | |
| 1-23 | | | | | | |
| 1-24 | | 10 | | | | |
| 1-25 | | | | | | |
| 1-26 | | | | | | |
| 1-27 | | 5 | | | | |
| 1-28 | | | | | | |

| | Thermally-conductive particles | | | | | |
|---|---|---|---|---|---|---|
| | Particle | | | | Maximum | |
| | diameter | G2/ | | Distribution | temperature | |
| Example | (μm) | G1 | Shape | in layer | (deg C.) | Evaluation |
| 1-17 | 2 | 10 | Scale-like | Uniform | 201 | good |
| 1-18 | 4 | | | | 163 | good |
| 1-19 | 6 | | | | 154 | good |
| 1-20 | 4 | | | | 201 | good |
| 1-21 | 6 | | | | 176 | good |
| 1-22 | 8 | | | | 169 | good |
| 1-23 | 10 | | | | 165 | good |
| 1-24 | 8 | | | | 203 | good |
| 1-25 | 11 | | | | 171 | good |
| 1-26 | 15 | | | | 166 | good |
| 1-27 | 10 | | | High | 155 | good |
| | | | | content on | | |
| | | | | current | | |
| | | | | collector | | |
| | | | | side | | |
| 1-28 | | | | Small | 168 | good |
| | | | | content on | | |
| | | | | current | | |
| | | | | collector | | |
| | | | | side | | |

TABLE 3
Location containing thermally-conductive particles: cathode (cathode
active material layer) or anode (anode active material layer)

| | Cathode active material | | Anode active material | | | |
|---|---|---|---|---|---|---|
| | | Particle | | Particle | Thermally-conductive particles | |
| | | diameter | | diameter | Containing | |
| Example | Type | (μm) | Type | (μm) | location | Type |
| 1-29 | LiNiO₂ | 5 | Si | 10 | Anode | B₂O₃ |
| | | | | | active | |
| | | | | | material | |
| | | | | | layer | |
| 1-30 | | | | | | |
| 1-31 | | | | | | B₄C |
| 1-32 | | | | | | |
| 1-33 | | | | | | SiC |
| 1-34 | | | | | | TiN |
| 1-35 | | | | | | TiN + BN |
| 1-36 | | | | | — | — |

| | Thermally-conductive particles | | | | | |
|---|---|---|---|---|---|---|
| | Particle | | | | Maximum | |
| | diameter | Content | | Distribution | temperature | |
| Example | (μm) | (wt %) | Shape | in layer | (deg C.) | Evaluation |
| 1-29 | 5 | 10 | Spherical | Uniform | 211 | good |
| 1-30 | | | Scale-like | | 204 | good |
| 1-31 | | | Spherical | | 202 | good |
| 1-32 | | | Scale-like | | 201 | good |
| 1-33 | | 1 | Scale-like | | 213 | good |
| 1-34 | | 10 | Spherical | | 220 | good |
| 1-35 | | | | | 189 | good |
| 1-36 | — | — | — | — | Unmeasurable | poor |

In the case where neither the cathode active material layer 21B nor the anode active material layer 22B contained the thermally-conductive particles, temperature was explosively increased due to self-heating of the secondary battery. Thereby, ignition and the like occurred, and therefore, the maximum temperature was not measurable. In contrast, in the case where the thermally-conductive particles having anisotropic heat conductivity were contained in the cathode active material layer 21B or the anode active material layer 22B, increased temperature caused by self-heating of the secondary battery was suppressed. Thereby, ignition and the like did not occur, and the maximum temperature was substantially kept to a value equal to or less than 200 deg C.

In the case where the content of the thermally-conductive particles in the cathode active material layer 21B was not uniform, when the content of the thermally-conductive particles was higher on the side closer to the cathode current collector 21A than on the side farther from the cathode current collector 21A, increased temperature caused by self-heating of the secondary battery was further suppressed, and therefore, the maximum temperature was further lowered.

In the case where the thermally-conductive particles were contained in the cathode active material layer 21B, when the particle diameter of the thermally-conductive particles was larger than the particle diameter of the primary particles of the cathode active material, the maximum temperature was further lowered. In contrast, in the case where the thermally-conductive particles were contained in the anode active material layer 22B, when the ratio G2/G1 was from 3.1 to 31 both inclusive, the maximum temperature was further lowered as well.

### Examples 2-1 to 2-56

Cylindrical-type lithium ion secondary batteries were fabricated by a procedure similar to those of Examples 1-1 to 1-36, except that the location containing the thermally-conductive particles was changed to the cathode covering layer 21C or the anode covering layer 22C.

In the case where the thermally-conductive particles were contained in the cathode covering layer 21C, the thermally-conductive particles (boron nitride HGP available from Denki Kagaku Kogyo Kabushiki Kaisha) and a binder (polyvinylidene fluoride) were mixed at a weight ratio of 1:1. Subsequently, the resultant mixture was dispersed in an organic solvent (N-methyl-2-pyrrolidone) to obtain slurry. Finally, the cathode active material layer 21B was formed on the cathode current collector 21A, and thereafter, the cathode active material layer 21B was coated with the slurry with the use of a bar coater, and the slurry was dried to form the cathode covering layer 21C.

In the case where the thermally-conductive particles were contained in the anode covering layer 22C, a procedure similar to that in the case of forming the foregoing cathode covering layer 21C was taken, except that the anode covering layer 22C was formed after the anode active material layer 22B was formed on the anode current collector 22A.

It is to be noted that, the particle diameter (the median diameter d50: μm) of the cathode active material, density M1 (area density: mg/cm²) of the cathode active material in the cathode active material layer 21B, the particle diameter D1 (the median diameter d50: μm) of the anode active material, the particle diameter D2 (the median diameter d50: μm) of the thermally-conductive particles, density M2 (area density: mg/cm²) of the thermally-conductive particles in the cathode covering layer 21C or the anode covering layer 22C, a ratio M2/M1, and the ratio D2/D1, and the like were as illustrated in Table 4 to Table 7.

In particular, in the case where the cathode covering layer 21C and the anode covering layer 22C were formed, orientation of the thermally-conductive particles in the cathode covering layer 21C or the anode covering layer 22C was controlled by changing viscosity of slurry. In the tables, “Present” in sections under “Orientation” illustrated in Table 4 to Table 7 refers to a state that the plurality of thermally-conductive particles were oriented so that the length direction thereof was oriented to the crossing direction DX. In contrast, in the table, “Absent” in sections under “Orientation” illustrated in Table 4 to Table 7 refers to a state that the plurality of thermally-conductive particles were not oriented (the orientation direction was at random).

Safety and cycle characteristics of the secondary battery were examined, and results illustrated in Table 4 to Table 7 were obtained.

Upon examining the safety, the maximum temperature (deg C) was measured, and presence or absence of ignition and the like was evaluated by a procedure similar to those of Examples 1-1 to 1-36.

Upon examining the cycle characteristics, two cycles of charge and discharge were performed on the secondary battery in the ambient temperature environment (23 deg C) to measure the discharge capacity. Thereafter, the secondary battery was charged and discharged in the same environment until the total number of cycles reached 100 cycles to measure the discharge capacity. From the result, capacity retention ratio (%)=(discharge capacity at the 100th cycle/discharge capacity at the second cycle)poor 100 was calculated. At the time of charge, charge was performed until the upper limit voltage reached 4.2 V at a current of 0.2 C. At the time of discharge, discharge was performed until the final voltage reached 2.7 V at a current of 0.2 C. It is to be noted that 0.2 C refers to a current value at which the battery capacity (the theoretical capacity) is fully discharged for five hours.

TABLE 4
Location containing thermally-conductive particles: cathode
(cathode covering layer) or anode (anode covering layer)

| | | | | Anode active material | | Thermally-conductive particles | | | |
|---|---|---|---|---|---|---|---|---|---|
| | Cathode active material | | | | Particle | | | Particle | |
| | | Particle | Density | | diameter | | | diameter | |
| | | diameter | M1 | | D1 | Containing | | D2 | Thickness |
| Example | Type | (μm) | (mg/cm²) | Type | (μm) | location | Type | (μm) | (μm) |
| 2-1 | LiNiO₂ | 5 | 20 | Si | 5 | Anode | BN | 0.45 | 5 |
| | | | | | | covering | | | |
| | | | | | | layer | | | |
| 2-2 | | | | | | | | 0.5 | |
| 2-3 | | | | | | | | 7.5 | |
| 2-4 | | | | | | | | 20 | |
| 2-5 | | | | | | | | 25 | |
| 2-6 | | | | | | | | 30 | |
| 2-7 | | | | | 55 | | | 5 | |
| 2-8 | | | | | 50 | | | | |
| 2-9 | | | | | 25 | | | | |
| 2-10 | | | | | 10 | | | | |
| 2-11 | | | | | 5.1 | | | | |
| 2-12 | | | | | 1 | | | | |
| 2-13 | | | | | 0.8 | | | | |
| 2-14 | | | | | 5 | | | | |

| | | | | | | Capacity | | |
|---|---|---|---|---|---|---|---|---|
| | Thermally-conductive particles | | | | | retention | Maximum | |
| | DensityM2 | | | M1/ | D2/ | ratio | temperature | |
| Example | (mg/cm²) | Shape | Orientation | M2 | D1 | (%) | (deg C.) | Evaluation |
| 2-1 | 0.5 | Scale-like | Present | 40 | 0.09 | 80 | 148 | good |
| 2-2 | | | | | 0.1 | 80 | 145 | good |
| 2-3 | | | | | 1.5 | 80 | 144 | good |
| 2-4 | | | | | 4 | 80 | 142 | good |
| 2-5 | | | | | 5 | 77 | 144 | good |
| 2-6 | | | | | 6 | 60 | 149 | good |
| 2-7 | | | | | 0.09 | 80 | 143 | good |
| 2-8 | | | | | 0.1 | 80 | 144 | good |
| 2-9 | | | | | 0.2 | 80 | 145 | good |
| 2-10 | | | | | 0.5 | 80 | 146 | good |
| 2-11 | | | | | 0.98 | 80 | 158 | good |
| 2-12 | | | | | 5 | 77 | 156 | good |
| 2-13 | | | | | 6.25 | 60 | 157 | good |
| 2-14 | | Spherical | Absent | 40 | 1 | 80 | 186 | good |

TABLE 5
Location containing thermally-conductive particles: cathode
(cathode covering layer) or anode (anode covering layer)

| | | | | Anode active material | | Thermally-conductive particles | | | |
|---|---|---|---|---|---|---|---|---|---|
| | Cathode active material | | | | Particle | | | Particle | |
| | | Particle | Density | | diameter | | | diameter | |
| | | diameter | M1 | | D1 | Containing | | D2 | Thickness |
| Example | Type | (μm) | (mg/cm²) | Type | (μm) | location | Type | (μm) | (μm) |
| 2-15 | LiNiO₂ | 5 | 20 | Si | 5 | Anode | BN | 5 | 5 |
| | | | | | | covering | | | |
| | | | | | | layer | | | |
| 2-16 | | | | | | | | | 2.3 |
| 2-17 | | | | | | | | | 1.2 |
| 2-18 | | | | | | | | | 0.7 |
| 2-19 | | | | | | | | | 6.5 |
| 2-20 | | | | | | | | | 7.5 |
| 2-21 | | | | | | | | | 8 |
| 2-22 | | | 40 | | | | | | 9.7 |
| 2-23 | | | | | | | | | 4.4 |
| 2-24 | | | | | | | | | 2.1 |
| 2-25 | | | | | | | | | 1.9 |
| 2-26 | | | | | | | | | 12.5 |
| 2-27 | | | | | | | | | 17 |
| 2-28 | | | | | | | | | 18.5 |

| | Thermally-conductive particles | | | | | Capacity | | |
|---|---|---|---|---|---|---|---|---|
| | Density | | | | | retention | Maximum | |
| | M2 | | | M1/ | D2/ | ratio | temperature | |
| Example | (mg/cm²) | Shape | Orientation | M2 | D1 | (%) | (deg C.) | Evaluation |
| 2-15 | 0.5 | Scale-like | Present | 40 | 1 | 80 | 144 | good |
| 2-16 | 0.2 | | | 100 | | 80 | 146 | good |
| 2-17 | 0.1 | | | 200 | | 80 | 148 | good |
| 2-18 | 0.09 | | | 222.2 | | 80 | 173 | good |
| 2-19 | 0.8 | | | 25 | | 76 | 143 | good |
| 2-20 | 1 | | | 20 | | 73 | 144 | good |
| 2-21 | 1.01 | | | 19.8 | | 72 | 169 | good |
| 2-22 | 1 | | | 40 | | 66 | 142 | good |
| 2-23 | 0.4 | | | 100 | | 80 | 148 | good |
| 2-24 | 0.2 | | | 200 | | 80 | 144 | good |
| 2-25 | 0.18 | | | 222.2 | | 80 | 161 | good |
| 2-26 | 1.6 | | | 25 | | 71 | 141 | good |
| 2-27 | 2 | | | 20 | | 68 | 148 | good |
| 2-28 | 2.1 | | | 19 | | 66 | 162 | good |

TABLE 6
Location containing thermally-conductive particles: cathode
(cathode covering layer) or anode (anode covering layer)

| | | | | Anode active material | | Thermally-conductive particles | | | |
|---|---|---|---|---|---|---|---|---|---|
| | Cathode active material | | | | Particle | | | Particle | |
| | | Particle | Density | | diameter | | | diameter | |
| | | diameter | M1 | | D1 | Containing | | D2 | Thickness |
| Example | Type | (μm) | (mg/cm²) | Type | (μm) | location | Type | (μm) | (μm) |
| 2-29 | LiNiO₂ | 5 | 20 | Si | 5 | Cathode | BN | 0.45 | 5 |
| | | | | | | covering | | | |
| | | | | | | layer | | | |
| 2-30 | | | | | | | | 0.5 | |
| 2-31 | | | | | | | | 7 | |
| 2-32 | | | | | | | | 20 | |
| 2-33 | | | | | | | | 25 | |
| 2-34 | | | | | | | | 30 | |
| 2-35 | | | | | 55 | | | 5 | |
| 2-36 | | | | | 50 | | | | |
| 2-37 | | | | | 25 | | | | |
| 2-38 | | | | | 10 | | | | |
| 2-39 | | | | | 5.1 | | | | |
| 2-40 | | | | | 1 | | | | |
| 2-41 | | | | | 0.8 | | | | |

| | | | | | | Capacity | | |
|---|---|---|---|---|---|---|---|---|
| | Thermally-conductive particles | | | | | retention | Maximum | |
| | DensityM2 | | | M1/ | D2/ | ratio | temperature | |
| Example | (mg/cm²) | Shape | Orientation | M2 | D1 | (%) | (deg C.) | Evaluation |
| 2-29 | 0.5 | Scale-like | Present | 40 | 0.09 | 80 | 148 | good |
| 2-30 | | | | | 0.1 | 80 | 145 | good |
| 2-31 | | | | | 1.5 | 80 | 144 | good |
| 2-32 | | | | | 4 | 80 | 142 | good |
| 2-33 | | | | | 5 | 77 | 144 | good |
| 2-34 | | | | | 6 | 60 | 149 | good |
| 2-35 | | | | | 0.09 | 80 | 143 | good |
| 2-36 | | | | | 0.1 | 80 | 144 | good |
| 2-37 | | | | | 0.2 | 80 | 145 | good |
| 2-38 | | | | | 0.5 | 80 | 146 | good |
| 2-39 | | | | | 0.98 | 80 | 158 | good |
| 2-40 | | | | | 5 | 77 | 156 | good |
| 2-41 | | | | | 6.25 | 60 | 157 | good |

TABLE 7
Location containing thermally-conductive particles: cathode
(cathode covering layer) or anode (anode covering layer)

| | | | | Anode active material | | Thermally-conductive particles | | | |
|---|---|---|---|---|---|---|---|---|---|
| | Cathode active material | | | | Particle | | | Particle | |
| | | Particle | Density | | diameter | | | diameter | |
| | | diameter | M1 | | D1 | Containing | | D2 | Thickness |
| Example | Type | (μm) | (mg/cm²) | Type | (μm) | location | Type | (μm) | (μm) |
| 2-42 | LiNiO₂ | 5 | 20 | Si | 5 | Cathode | BN | 5 | 5 |
| | | | | | | covering | | | |
| | | | | | | layer | | | |
| 2-43 | | | | | | | | | 2.3 |
| 2-44 | | | | | | | | | 1.2 |
| 2-45 | | | | | | | | | 0.7 |
| 2-46 | | | | | | | | | 6.5 |
| 2-47 | | | | | | | | | 7.5 |
| 2-48 | | | | | | | | | 8 |
| 2-49 | | | 40 | | | | | | 9.7 |
| 2-50 | | | | | | | | | 4.4 |
| 2-51 | | | | | | | | | 2.1 |
| 2-52 | | | | | | | | | 1.9 |
| 2-53 | | | | | | | | | 12.5 |
| 2-54 | | | | | | | | | 17 |
| 2-55 | | | | | | | | | 18.5 |
| 2-56 | LiNiO₂ | 5 | 20 | Si | 5 | — | — | — | — |

| | Thermally-conductive particles | | | | | Capacity | | |
|---|---|---|---|---|---|---|---|---|
| | Density | | | | | retention | Maximum | |
| | M2 | | | M1/ | D2/ | ratio | temperature | |
| Example | (mg/cm²) | Shape | Orientation | M2 | D1 | (%) | (deg C.) | Evaluation |
| 2-42 | 0.5 | Scale-like | Present | 40 | 1 | 80 | 144 | good |
| 2-43 | 0.2 | | | 100 | | 80 | 146 | good |
| 2-44 | 0.1 | | | 200 | | 80 | 148 | good |
| 2-45 | 0.09 | | | 222.2 | | 80 | 173 | good |
| 2-46 | 0.8 | | | 25 | | 76 | 143 | good |
| 2-47 | 1 | | | 20 | | 73 | 144 | good |
| 2-48 | 1.01 | | | 19.8 | | 72 | 154 | good |
| 2-49 | 1 | | | 40 | | 66 | 142 | good |
| 2-50 | 0.4 | | | 100 | | 80 | 148 | good |
| 2-51 | 0.2 | | | 200 | | 80 | 144 | good |
| 2-52 | 0.18 | | | 222.2 | | 80 | 161 | good |
| 2-53 | 1.6 | | | 25 | | 71 | 141 | good |
| 2-54 | 2 | | | 20 | | 68 | 148 | good |
| 2-55 | 2.1 | | | 19 | | 66 | 152 | good |
| 2-56 | — | — | — | — | — | 80 | Unmeasurable | poor |

In the case where neither the cathode covering layer 21C nor the anode covering layer 22C that contained the thermally-conductive particles was formed, temperature was explosively increased due to self-heating of the secondary battery. Thereby, ignition and the like occurred, and therefore, the maximum temperature was not measurable. In contrast, in the case where the cathode covering layer 21C or the anode covering layer 22C that contained the thermally-conductive particles was formed, ignition and the like did not occur and the maximum temperature was substantially kept to a value less than 170 deg C while a high capacity retention ration was retained.

In the case where the cathode covering layer 21C or the anode covering layer 22C was formed, when the shape of the thermally-conductive particles was scale-like and the thermally-conductive particles were oriented so that the length direction was oriented to the crossing direction DX, the maximum temperature was further lowered.

In the case where the cathode covering layer 21C was formed, when the ratio M1/M2 was from 20 to 200 both inclusive, the maximum temperature was further lowered. In contrast, in the case where the anode covering layer 22C was formed, when the ratio D2/D1 was from 0.1 to 5 both inclusive, the maximum temperature was further lowered.

### Examples 3-1 to 3-7

Cylindrical-type lithium ion secondary batteries were fabricated by a procedure similar to those of Examples 1-1 to 1-36, except that the location containing the thermally-conductive particles was changed to the separator covering layer 23B.

In the case where the thermally-conductive particles were contained in the separator covering layer 23B, the thermally-conductive particles (boron nitride HGP available from Denki Kagaku Kogyo Kabushiki Kaisha) and a binder (polyvinylidene fluoride) were mixed at a dry weight ratio of 9:1. Subsequently, the resultant mixture was dispersed in an organic solvent (N-methyl-2-pyrrolidone) to obtain slurry. Finally, the both surfaces of the porous layer 23A were coated with the slurry with the use of a bar coater, and the slurry was dried to form the separator covering layer 23B. The material, the thickness (μm), and the like of the porous layer 23A were as illustrated in Table 8. For comparison, the separator 23 was formed by a procedure similar to the foregoing procedure, except that the thermally-conductive particles were contained in the porous layer 23A instead of the separator covering layer 23B.

Safety of the secondary battery was examined, and results illustrated in Table 8 were obtained. Upon examining the safety, the maximum temperature (deg C) was measured, and presence or absence of ignition and the like were evaluated by a procedure similar to those of Examples 1-1 to 1-36, except that the environment temperature was changed to 150 deg C. In these examples, time (retention time: minutes) until temperature of the secondary battery reached the maximum temperature was examined as well.

TABLE 8
Location containing thermally-conductive particles: separator (separator covering layer)

| | | | Anode active material | | | | Thermally-conductive particles | | |
|---|---|---|---|---|---|---|---|---|---|
| | Cathode active material | | | Particle | Porous | | | Particle | |
| | | Density | | diameter | layer | | | diameter | |
| | | M1 | | D1 | | Thickness | | D2 | Thickness |
| Example | Type | (mg/cm²) | Type | (μm) | Type | (μm) | Type | (μm) | (μm) |
| 3-1 | LiNiO₂ | 20 | Si | 5 | PET | 12 | BN | 5 | 5 |
| 3-2 | | | | | | | | | 10 |
| 3-3 | | | | | | 20 | | | 5 |
| 3-4 | | | | | | | | 10 | 10 |
| 3-5 | LiNiO₂ | 20 | Si | 5 | PET | 12 | — | — | — |
| 3-6 | | | | | | 20 | | | |

| | | | | | | | |
|---|---|---|---|---|---|---|---|
| 3-7 | LiNiO₂ | 20 | Si | 5 | PET | 12 | Contained in porous layer |

| | Thermally-conductive particles | | | | | | | |
|---|---|---|---|---|---|---|---|---|
| | Density | | | | | Maximum | | |
| | M2 | | | M1/ | D2/ | temperature | Retention time | |
| Example | (mg/cm²) | Shape | Orientation | M2 | D1 | (deg C.) | (min) | Evaluation |
| 3-1 | 0.5 | Scale-like | Present | 40 | 1 | 165 | >60 | good |
| 3-2 | 1 | | | 20 | 1 | 165 | >60 | good |
| 3-3 | 0.5 | | | 40 | 1 | 165 | <10 | good |
| 3-4 | 1 | | | 20 | 2 | 165 | >60 | good |
| 3-5 | — | — | — | — | — | >180 | <1 | poor |
| 3-6 | | | | | | >180 | <1 | poor |

| | | | | |
|---|---|---|---|---|
| 3-7 | Contained in porous layer | Unmeasurable | Unmeasurable | poor |

In the case where the separator covering layer 23B containing the thermally-conductive particles was not formed, temperature was explosively increased to a value equal to or higher than 180 deg C due to self-heating of the secondary battery, and therefore, ignition and the like occurred. Further, in the case where the thermally-conductive particles were contained in the porous layer 23A, ignition and the like also occurred due to self-heating of the secondary battery. In contrast, in the case where the separator covering layer 23B containing the thermally-conductive particles was formed, ignition and the like did not occur and the maximum temperature was kept to a value less than 180 deg C.

From the results of Table 1 to Table 8, in the case where one or more of the cathode, the anode, and the separator contained the plurality of thermally-conductive particles in the region between the cathode current collector and the anode current collector, and the heat conductivity of the thermally-conductive particles had anisotropy, superior safety was obtained.

The present technology has been described with reference to the embodiment and Examples. However, the present technology is not limited to the examples described in the embodiment and Examples, and various modifications may be made. For example, the description has been given with the specific examples of the case in which the battery structure is the cylindrical-type or the laminated-film-type, and the battery element has the spirally wound structure. However, applicable structures are not limited thereto. The secondary battery of the present technology is similarly applicable to a battery having other battery structure such as a square-type battery, a coin-type battery, and a button-type battery, or a battery in which the battery element has other structure such as a laminated structure.

Further, although the description has been given of the case in which lithium is used as an electrode reactant, the electrode reactant is not limited to lithium. The electrode reactant may be, for example, other Group 1 element such as sodium (Na) and potassium (K), a Group 2 element such as magnesium (Mg) and calcium (Ca), or other light metal such as aluminum (Al). The effect of the present technology may be obtained without depending on the electrode reactant type, and therefore, even if the electrode reactant type is changed, a similar effect is obtainable.

Further, in the embodiment and Examples, with regard to the ratio G2/G1, the description has been given of the appropriate range derived from the results of Examples. However, the description does not totally deny a possibility that the ratio G2/G1 is out of the foregoing appropriate range. That is, the foregoing appropriate range is a range particularly preferable for obtaining the effects of the present technology. Therefore, as long as the effects of the present technology are obtained, the ratio G2/G1 may be out of the foregoing appropriate range in some degrees. The same is similarly applicable to the ratio M1/M2 the ratio D2/D1.

It is possible to achieve at least the following configurations from the above-described example embodiments of the disclosure.

(1) A secondary battery including:

a cathode and an anode that are opposed to each other with a separator in between; and

an electrolytic solution, wherein

the cathode includes a cathode current collector and a cathode active material layer provided between the cathode current collector and the separator,

the anode includes an anode current collector and an anode active material layer provided between the anode current collector and the separator,

one or more of the cathode, the anode, and the separator includes a plurality of thermally-conductive particles in a region between the cathode current collector and the anode current collector, and

heat conductivity of the thermally-conductive particles is larger in a second direction that intersects with a first direction, in which the cathode and the anode are opposed to each other, than in the first direction.

(2) The secondary battery according to (1), wherein

each of the thermally-conductive particles has a shape in which a length is larger than a thickness, and

the thermally-conductive particles are oriented so that a direction of the length is directed to the second direction.

(3) The secondary battery according to (2), wherein the thermally-conductive particles are platy.
(4) The secondary battery according to any one of (1) to (3), wherein

the thermally-conductive particles include fine ceramics, and

the fine ceramics does not contain oxygen (O) as a constituent element.

(5) The secondary battery according to any one of (1) to (4), wherein the thermally-conductive particles include boron nitride (BN).
(6) The secondary battery according to any one of (1) to (5), wherein a melting point of the thermally-conductive particles is higher than one or both of melting points of the cathode current collector and the anode current collector.
(7) The secondary battery according to any one of (1) to (6), wherein the thermally-conductive particles are contained in one or both of the cathode active material layer and the anode active material layer.
(8) The secondary battery according to (7), wherein a content of the thermally-conductive particles in the cathode active material layer or the anode active material layer is larger on a side closer to the cathode current collector or the anode current collector than on a side farther from the cathode current collector or the anode current collector.
(9) The secondary battery according to (7) or (8), wherein

the thermally-conductive particles are contained in the cathode active material layer together with a cathode active material, and

a median diameter (d50: nm) of the thermally-conductive particles is larger than a median diameter (d50: nm) of primary particles of the cathode active material.

(10) The secondary battery according to any one of (7) to (9), wherein

the thermally-conductive particles are contained in the anode active material layer together with an anode active material, and

a ratio G2/G1 between a weight G1 of the anode active material and a weight G2 of the thermally-conductive particles is from about 3.1 percent to about 31 percent both inclusive.

(11) The secondary battery according to any one of (1) to (6), wherein

one or both of the cathode and the anode include an electrode covering layer provided between the cathode active material layer and the separator or between the anode active material layer and the separator, and

the thermally-conductive particles are contained in the electrode covering layer.

(12) The secondary battery according to (11), wherein

each of the thermally-conductive particles has a shape in which a length is larger than a thickness, and are oriented so that a direction of the length is directed to the second direction, and

adjacent particles of the thermally-conductive particles partly overlap each other.

(13) The secondary battery according to (11) or (12), wherein

the cathode active material layer includes a cathode active material,

the electrode covering layer is provided between the cathode active material layer and the separator, and

a ratio M1/M2 between an area density M1 (mg/cm²) of the cathode active material in the cathode active material layer and an area density M2 (mg/cm²) of the thermally-conductive particles in the electrode covering layer is from about 20 to about 200 both inclusive.

(14) The secondary battery according to (11) or (12), wherein

the anode active material layer includes an anode active material,

the electrode covering layer is provided between the anode active material layer and the separator, and

a ratio D2/D1 between a median diameter D1 (d50: μm) of the anode active material and a median diameter D2 (d50: μm) of the thermally-conductive particles is from about 0.1 to about 5 both inclusive.

(15) The secondary battery according to any one of (1) to (6), wherein

the separator includes a porous layer and a separator covering layer provided between the porous layer and one or both of the cathode active material layer and the anode active material layer, and

the thermally-conductive particles are contained in the separator covering layer.

(16) The secondary battery according to (15), wherein

each of the thermally-conductive particles has a shape in which a length is larger than a thickness, and are oriented so that a direction of the length is directed to the second direction, and

adjacent particles of the thermally-conductive particles partly overlap each other.

(17) The secondary battery according to any one of (1) to (16), wherein

the cathode current collector includes aluminum (Al) as a constituent element, and

the anode current collector includes copper (Cu) as a constituent element.

(18) The secondary battery according to any one of (1) to (17), wherein

the cathode active material layer includes a cathode active material,

the cathode active material includes lithium (Li), one or more of nickel (Ni), cobalt (Co) and manganese (Mn), and oxygen as constituent elements,

the anode active material layer includes an anode active material, and

the anode active material includes one or both of silicon (Si) and tin (Sn) as constituent elements.

(19) The secondary battery according to any one of (1) to (18), wherein the secondary battery is a lithium secondary battery.

It should be understood by those skilled in the art that various modifications, combinations, sub-combinations and alternations may occur depending on design requirements and other factors insofar as they are within the scope of the appended claims or the equivalents thereof

What is claimed is:

1. A secondary battery comprising:
a cathode and an anode that are opposed to each other with a separator in between; and
an electrolytic solution, wherein
the cathode includes a cathode current collector and a cathode active material layer provided between the cathode current collector and the separator,
the anode includes an anode current collector and an anode active material layer provided between the anode current collector and the separator,
one or more of the cathode, the anode, and the separator includes a plurality of thermally-conductive particles in a region between the cathode current collector and the anode current collector, and
heat conductivity of the thermally-conductive particles is larger in a second direction that intersects with a first direction, in which the cathode and the anode are opposed to each other, than in the first direction.

2. The secondary battery according to claim 1, wherein
each of the thermally-conductive particles has a shape in which a length is larger than a thickness, and
the thermally-conductive particles are oriented so that a direction of the length is directed to the second direction.

3. The secondary battery according to claim 2, wherein the thermally-conductive particles are platy.

4. The secondary battery according to claim 1, wherein
the thermally-conductive particles include fine ceramics, and
the fine ceramics does not contain oxygen (O) as a constituent element.

5. The secondary battery according to claim 1, wherein the thermally-conductive particles include boron nitride (BN).

6. The secondary battery according to claim 1, wherein a melting point of the thermally-conductive particles is higher than one or both of melting points of the cathode current collector and the anode current collector.

7. The secondary battery according to claim 1, wherein the thermally-conductive particles are contained in one or both of the cathode active material layer and the anode active material layer.

8. The secondary battery according to claim 7, wherein a content of the thermally-conductive particles in the cathode active material layer or the anode active material layer is larger on a side closer to the cathode current collector or the anode current collector than on a side farther from the cathode current collector or the anode current collector.

9. The secondary battery according to claim 7, wherein
the thermally-conductive particles are contained in the cathode active material layer together with a cathode active material, and
a median diameter (d50: μm) of the thermally-conductive particles is larger than a median diameter (d50: μm) of primary particles of the cathode active material.

10. The secondary battery according to claim 7, wherein
the thermally-conductive particles are contained in the anode active material layer together with an anode active material, and
a ratio G2/G1 between a weight G1 of the anode active material and a weight G2 of the thermally-conductive particles is from about 3.1 percent to about 31 percent both inclusive.

11. The secondary battery according to claim 1, wherein
one or both of the cathode and the anode include an electrode covering layer provided between the cathode active material layer and the separator or between the anode active material layer and the separator, and
the thermally-conductive particles are contained in the electrode covering layer.

12. The secondary battery according to claim 11, wherein
each of the thermally-conductive particles has a shape in which a length is larger than a thickness, and are oriented so that a direction of the length is directed to the second direction, and
adjacent particles of the thermally-conductive particles partly overlap each other.

13. The secondary battery according to claim 11, wherein
the cathode active material layer includes a cathode active material,
the electrode covering layer is provided between the cathode active material layer and the separator, and
a ratio M1/M2 between an area density M1 (mg/cm²) of the cathode active material in the cathode active material layer and an area density M2 (mg/cm²) of the thermally-conductive particles in the electrode covering layer is from about 20 to about 200 both inclusive.

14. The secondary battery according to claim 11, wherein
the anode active material layer includes an anode active material,
the electrode covering layer is provided between the anode active material layer and the separator, and
a ratio D2/D1 between a median diameter D1 (d50: μm) of the anode active material and a median diameter D2 (d50: μm) of the thermally-conductive particles is from about 0.1 to about 5 both inclusive.

15. The secondary battery according to claim 1, wherein
the separator includes a porous layer and a separator covering layer provided between the porous layer and one or both of the cathode active material layer and the anode active material layer, and
the thermally-conductive particles are contained in the separator covering layer.

16. The secondary battery according to claim 15, wherein
each of the thermally-conductive particles has a shape in which a length is larger than a thickness, and are oriented so that a direction of the length is directed to the second direction, and
adjacent particles of the thermally-conductive particles partly overlap each other.

17. The secondary battery according to claim 1, wherein
the cathode current collector includes aluminum (Al) as a constituent element, and
the anode current collector includes copper (Cu) as a constituent element.

18. The secondary battery according to claim 1, wherein
the cathode active material layer includes a cathode active material,
the cathode active material includes lithium (Li), one or more of nickel (Ni), cobalt (Co) and manganese (Mn), and oxygen as constituent elements,
the anode active material layer includes an anode active material, and
the anode active material includes one or both of silicon (Si) and tin (Sn) as constituent elements.

19. The secondary battery according to claim 1, wherein the secondary battery is a lithium secondary battery.
